(19) United States
(12) Patent Application Publication
(10) Pub. No.: US 2022/0312223 A1
(43) Pub. Date: Sep. 29, 2022

(54) STATION PLACEMENT ASSISTANCE METHOD

(71) Applicant: NIPPON TELEGRAPH AND TELEPHONE CORPORATION, Tokyo (JP)

(72) Inventors: Hideyuki TSUBOI, Musashino-shi, Tokyo (JP); Hideki TOSHINAGA, Musashino-shi, Tokyo (JP); Kazuto GOTO, Musashino-shi, Tokyo (JP); Shuki WAI, Musashino-shi, Tokyo (JP); Yushi SHIRATO, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 17/640,098

(22) PCT Filed: Sep. 5, 2019
(86) PCT No.: PCT/JP2019/034976

§ 371 Date: Mar. 3, 2022

(51) Int. Cl. H04W 16/18; G01S 5/00

(52) U.S. Cl. CPC H04W 16/18; G01S 5/0081

(57) ABSTRACT

In two-dimensional map data showing buildings to be candidates in which terminal station devices are to be installed, a position of a base station installation structure to be a candidate in which a base station device is to be installed is set as a base station candidate position, an unobstructed view for each of the buildings from the base station candidate position is determined based on the map data while excluding a region blocked by the building having an unobstructed view from the base station candidate position, and a range of a contour line having an unobstructed view of the building determined as having the unobstructed view is detected as an unobstructed view range. A candidate of, among wall surfaces of the building corresponding to the detected unobstructed view range, the wall surface on which the terminal station device can be installed is extracted. Three-dimensional point group data obtained by taking an image of a region including the base station installation structure and the building is narrowed down using information concerning the extracted wall surface. An unobstructed view for the building from the base station candidate position is determined using the narrowed-down point group data.

### TECHNICAL FIELD

The present invention is, for example, a station installation support method for supporting station installation design for selecting places where a base station device and a terminal station device are installed.

### BACKGROUND ART

FIG. 41 is a figure cited from Non-Patent Literatures 1 to 3 and is a figure showing an overview of millimeter wave wireless communication performed between base station devices (hereinafter referred to as “base stations”) installed in utility poles and terminal station devices (hereinafter referred to as “terminal stations”) installed in buildings such as houses. In FIG. 41, a use case proposed by mmWave Networks in a TIP (Telecom Infra Project), which is a consortium that achieves specification open promotion of communication NW (Network) devices in general, is shown. Main members of the TIP are Facebook, Deutsche, Telecom, Intel, NOKIA, and the like. The mmWave Networks is one of project groups of the TIP and aims at constructing a NW more quickly and inexpensively than laying optical fibers using millimeter wave radio in an un-license band. Note that, in FIG. 41, signs 610, 611, 612, 620, 621, 622, and 623 are added by the applicant.

In regions 610 and 620 shown in FIG. 41, buildings 611 and 621 such as office buildings and a building 622 such as a house are set. A terminal station is set on a wall surface of each of the buildings 611, 621, and 622. Poles 612 and 623 such as utility poles are set in the regions 610 and 620. Base stations are installed in the poles. The base station installed in the pole 612 performs communication with the terminal station installed on the wall surface of the building 611. The base station installed in the pole 623 performs communication with the terminal stations installed on the wall surfaces of the buildings 621 and 622. These kinds of communication are performed by millimeter wave radio.

In a form shown in FIG. 41, selecting candidate positions where the base stations and the terminal stations are installed is referred to as station installation design (hereinafter referred to as “station installation” as well.

### CITATION LIST

### Patent Literature

Patent Literature 1: Japanese Patent No. 4295746

### Non-Patent Literature

Non-Patent Literature 1: Sean Kinney, “Telecom Infra Project focuses on millimeter wave for dense networks, Millimeter Wave Networks Project Group eyes 60 GHz band”, Image courtesy of the Telecom Infra Project, RCR Wireless News, Intelligence on all things wireless, Sep. 13, 2017, [searched on Aug. 14, 2019], Internet (URL: https://www.rcrwireless.com/20170913/carriers/telecom-infra-project-millimeter-wave-tag17)
Non-Patent Literature 2: Frederic Lardinois, “Facebook-backed Telecom Infra Project adds a new focus on millimeter wave tech for 5G”, [searched on Aug. 14, 2019], Internet (URL: https://techcrunch.com/2017/09/12/facebook-backed-telecom-infra-project-adds-a-new-focus-on-millimeter-wave-tech-for-5g/?renderMode=ie11)
Non-Patent Literature 3: Jamie Davies, “DT and Facebook TIP the scales for mmWave”, GLOTEL AWARDS 2019, telecoms.com, Sep. 12, 2017, [searched on Aug. 14, 2019], Internet (URL: http://telecoms.com/484622/dt-and-facebook-tip-the-scales-for-mmwave/)

### SUMMARY OF THE INVENTION

### Technical Problem

As a method of performing station installation design, there is a method of using three-dimensional point group data obtained by imaging a space. In this method, processing explained below is performed. As first processing, a vehicle mounted with a MMS (Mobile Mapping System) is run along roads around an evaluation target housing area to acquire three-dimensional point group data. As second processing, ranges viewed without obstruction from utility poles, in which base stations are installed, on a wall surface of an evaluation target building are calculated using three-dimensional point group data obtained. The ranges calculated in this way are candidates of positions where terminal stations are installed.

Even when a relatively simple method of evaluating presence or absence of an unobstructed view is adopted in a method of evaluating the quality of wireless communication, since it is necessary to handle point group data of three-dimensional data, enormous calculation resources and calculation time are required. Accordingly, it is effective to adopt a method of narrowing down candidate positions of base stations and terminal stations on a two-dimensional map and performing evaluation using partial point group data between the base stations and the terminal stations in the narrowed-down candidate positions or only the peripheries of the candidate positions.

When such a method is adopted, in order to evaluate an unobstructed view for one base station, it is necessary to evaluate unobstructed views for the base station of all buildings present in a range designated on a map. However, there is a problem in that a lot of labor and time are necessary for the evaluation.

In view of the circumstances described above, an object of the present invention is to provide a technique that can narrow down the number of evaluation target buildings when evaluating unobstructed views using two-dimensional map data.

### Means for Solving the Problem

An aspect of the present invention is a station installation support method including: an unobstructed-view-determination processing step for, in two-dimensional map data showing buildings to be candidates in which terminal station devices are to be installed, setting, as a base station candidate position, a position of a base station installation structure to be a candidate in which a base station device is to be installed, determining an unobstructed view for each of the buildings from the base station candidate position based on the map data while excluding a region blocked by the building having an unobstructed view from the base station candidate position, and detecting, as an unobstructed view range, a range of a contour line having an unobstructed view of the building determined as having the unobstructed view; an installation-wall-surface-candidate extraction step for extracting a candidate of, among wall surfaces of the building corresponding to the detected unobstructed view range, the wall surface on which the terminal station device can be installed; and a point-group-data processing step for narrowing down, using information concerning the extracted wall surface, three-dimensional point group data obtained by taking an image of a region including the base station installation structure and the building and determining, using the narrowed-down point group data, an unobstructed view for the building from the base station candidate position.

In the station installation support method according to the aspect of the present invention, the unobstructed-view-determination processing step includes: an evaluation-range selection step for selecting, as an evaluation range of unobstructed view determination, a range that is centered on the base station candidate position and is to be expanded stepwise; a building detection step for detecting, for each the evaluation range in respective stages, the building partially or entirely included in the evaluation range; an unobstructed-view-range detection step for detecting, with respect to the detected building, a range of a contour line having an obstructed view of the building and detecting the detected range of the contour line as an unobstructed view range of the building; and a blocking-direction detection step for detecting a range of a blocking direction blocked by the detected unobstructed view range. In the unobstructed-view-range detection step, when the entire building as an unobstructed view determination target is included in the range of the blocking direction, the building is excluded from detection targets of the contour line having the unobstructed view.

In the station installation support method according to the aspect of the present invention, the unobstructed-view-determination processing step includes: an unobstructed-view-detection-line setting step for rotating, in one direction, an unobstructed view detection line starting from the base station candidate position, a line length of the unobstructed view detection line increasing stepwise; an intersection detection step for detecting an intersection of the unobstructed view detection line and a contour line of the building, a distance of the intersection from the base station candidate position being smallest, and detecting intersection data indicating a coordinate of the detected intersection, building identification data indicating the building in which the intersection is present, line segment identification data indicating to which side of the building the intersection belongs, and direction data indicating a direction of the unobstructed view detection line; an unobstructed-view-range detection step for extracting the intersection data in which the building identification data is same and the line segment identification data is same, generating a line segment connecting coordinates of the intersection data included in the extracted combination, and detecting the generated line segment as an unobstructed view range of the building corresponding to the building identification data; and a blocking-direction detection step for detecting a range of a blocking direction blocked by the detected unobstructed view range. In the intersection detection step, when the intersection corresponding to the direction of the unobstructed view detection line is already detected or when the direction of the unobstructed view detection line is included in the blocking direction, the detection of the intersection is not performed.

In the station installation support method according to the aspect of the present invention, in the unobstructed-view-range detection step, when a coordinate of a vertex of the building is included in an inside of a circle forming a track of an end point at a time when the unobstructed view detection line is rotated once, the detection of the unobstructed view range is performed and, when the coordinate of the vertex of the building is not included in the inside of the circle, the detection of the unobstructed view range is not performed.

In the station installation support method according to the aspect of the present invention, the unobstructed-view-determination processing step includes: a distance detection step for detecting, for each the building, a distance from the base station candidate position; an unobstructed-view-range detection step for detecting buildings having unobstructed views in order from the building, the distance of which from the base station candidate position is shortest, detecting a range of a contour line having an unobstructed view of the building having the unobstructed view, and detecting the detected contour line as an unobstructed view range of the building; and a blocking-direction detection step for detecting a range of a blocking direction blocked by the detected unobstructed view range. In the unobstructed-view-range detection step, when the entire building as an unobstructed view determination target is included in the range of the blocking direction, the building is excluded from detection targets of the contour line having the unobstructed view.

In the station installation support method according to the aspect of the present invention, the unobstructed-view-determination processing step includes: a detection-direction setting step for setting one direction determined in advance around the base station candidate position as a designated detection direction and setting, as an auxiliary detection direction, an angle rotated at a predetermine rotation angle interval with respect to the designated detection direction; an intersection detection step for detecting an intersection with a contour line of the building that a straight line extended in the designated detection direction or the auxiliary detection direction starting from the base station candidate position crosses first and detecting intersection data indicating a coordinate of the detected intersection, building identification data indicating the building in which the intersection is present, and line segment identification data indicating to which side of the building the intersection belongs; a blocking-direction detection step for, when a pair or more of the intersections detected by the intersection detection step are present in the same building, detecting a range of a blocking direction based on the designated detection direction or the auxiliary detection direction at a time when each of the intersections is detected; and an unobstructed-view-range detection step for extracting the intersection data in which the building identification data is same and the line segment identification data is same, generating a line segment connecting coordinates of the intersection data included in the extracted combination, and detecting the generated line segment as an unobstructed view range of the building corresponding to the building identification data. In the detection-direction setting step, when the angle in the auxiliary detection direction is 360° or more, a half angle of the predetermined rotation angle interval is set as a new predetermined rotation angle interval, an angle rotated at the new predetermined rotation angle interval in the designated detection direction is set as the auxiliary detection direction. In the intersection detection step, when a direction of the designated detection direction or the auxiliary detection direction is included in the range of the blocking direction, the detection of the intersection is not performed.

In the station installation support method according to the aspect of the present invention, the unobstructed-view-determination processing step includes: a polar-coordinate-data generation step for generating, for each the building, contour line data of an orthogonal coordinate system indicating a contour line of the building included in the map data and converting the generated contour line data of the orthogonal coordinate system for each the building into contour line data of a polar coordinate system indicated by a distance and a direction based on the base station candidate position; and an unobstructed-view-range detection step for extracting the contour line data of the polar coordinate system in a portion at a shortest distance from the base station candidate position in respective directions and dividing the extracted contour line data of the polar coordinate system for each the building and detecting, as an unobstructed view range for each the building, the contour line data of the polar coordinate system divided for each the building.

In the station installation support method according to the aspect of the present invention, in the unobstructed-view-range detection step, when a shape of the building is a shape having a projecting part obtained by combining a rectangular shape with a rectangular shape, the unobstructed view range of the building is detected based on a plurality of regions obtained by dividing a region other than the region of the building with an auxiliary line obtained by extending the contour line of the building and an auxiliary line obtained by extending a line connecting a vertex of the projecting part and another vertex of the building viewed without obstruction from the vertex of the projecting part through an outside of the region of the building and based on the base station candidate position.

In the station installation support method according to the aspect of the present invention, in the installation-wall-surface-candidate extraction step, a region around the building is divided by an auxiliary line obtained by extending a bisector of an interior angle of the building to an outside of the region of the building and an auxiliary line obtained by extending the contour line of the building and detecting, based on in which of divided regions the base station candidate position is present, a wall surface of the building to be a candidate of an installation position of the terminal station device in the unobstructed view range detected by the unobstructed-view-range detection step.

### Effect of the Invention

According to the present invention, when an unobstructed view is evaluated using two-dimensional map data, it is possible to narrow down the number of evaluation target buildings.

### BRIEF DESCRIPTION OF DRAWINGS

FIG. 1 is a block diagram showing the configuration of a station installation support device in a basic embodiment.

FIG. 2 is a flowchart showing a flow of processing of the station installation support device in the basic embodiment.

FIG. 3 is a diagram for explaining the processing in the basic embodiment divided into two stages.

FIG. 4 is a block diagram showing the configuration of a station installation support device in a first embodiment.

FIG. 5 is a flowchart showing a flow of processing of the station installation support device in the first embodiment.

FIG. 6 is a diagram showing stages of an evaluation range in the first embodiment.

FIG. 7 is a diagram showing an evaluation range in a first stage in the first embodiment.

FIG. 8 is a diagram showing an evaluation range in a second stage in the first embodiment.

FIG. 9 is a diagram in which the evaluation range is expanded to a fourth stage in the first embodiment.

FIG. 10 is a block diagram showing the configuration of a station installation support device in a second embodiment.

FIG. 11 is a flowchart showing a flow of processing of the station installation support device in the second embodiment.

FIG. 12 is a diagram showing detection of an unobstructed view range by an unobstructed view detection line in the second embodiment.

FIG. 13 is a diagram showing an example of a state in which the unobstructed view range is not detected in the second embodiment.

FIG. 14 is a diagram showing an example of a state the unobstructed view range is detected in the second embodiment.

FIG. 15 is a diagram showing an example of a detection stage of the unobstructed view range in the second embodiment.

FIG. 16 is a diagram showing, as a table, a relation between the length of the unobstructed view detection line and a detection angle width applied to the second embodiment.

FIG. 17 is a block diagram showing the configuration of a station installation support device in a third embodiment.

FIG. 18 is a flowchart showing a flow of processing of the station installation support device in the third embodiment.

FIG. 19 is a diagram showing a detection state of an unobstructed view range in the third embodiment.

FIG. 20 is a block diagram showing the configuration of a station installation support device in a fourth embodiment.

FIG. 21 is a flowchart showing a flow of processing of the station installation support device in the fourth embodiment.

FIG. 22 is a diagram showing a state until a rotation angle interval is divided into two in the fourth embodiment.

FIG. 23 is a diagram showing a state in which the rotation angle interval is divided into three in the fourth embodiment.

FIG. 24 is a block diagram showing the configuration of a station installation support device in a fifth embodiment.

FIG. 25 is a flowchart showing a flow of processing of the station installation support device in the fifth embodiment.

FIG. 26 is a diagram showing directions of a polar coordinate system in the fifth embodiment.

FIG. 27 is a diagram showing, as a graph in which the horizontal axis indicates a direction and the vertical axis indicates a distance, a contour line of a building indicated by a polar coordinate system in the fifth embodiment.

FIG. 28 is a diagram for explaining an overview of a method described in Patent Literature 1.

FIG. 29 is a diagram showing an example of a building having a shape obtained by adding a rectangular-shaped projecting part to a rectangular shape and an auxiliary line set in the building.

FIG. 30 is a flowchart showing a flow of processing by another configuration example of an unobstructed-view-range detection unit in the first and third embodiments.

FIG. 31 is a diagram (No. 1) showing processing of detection of an unobstructed view range in the building having the shape shown in FIG. 29.

FIG. 32 is a diagram (No. 2) showing the processing of detection of an unobstructed view range in the building having the shape shown in FIG. 29.

FIG. 33 is a diagram (No. 1) showing processing of detection of an unobstructed view range in the case of a building having a shape in which two auxiliary lines can be set by a projecting part.

FIG. 34 is a diagram (No. 2) showing the processing of detection of an unobstructed view range in the case of the building having the shape in which the two auxiliary lines can be set by the projecting part.

FIG. 35 is a diagram for explaining means for detecting an unobstructed view range in the case in which a building having a shape obtained by adding a rectangular-shaped projecting part to a rectangular shape and a building having a rectangular shape are close.

FIG. 36 is a block diagram showing the configuration of a station installation support device in a sixth embodiment.

FIG. 37 is a flowchart showing a flow of processing of the station installation support device in the sixth embodiment.

FIG. 38 is a diagram showing processing in the case in which the shape of a building is a rectangular shape in the sixth embodiment.

FIG. 39 is a diagram showing processing in the case in which the shape of a building is a shape having a projecting part in the sixth embodiment.

FIG. 40 is a diagram showing a table in which overviews and characteristics of the embodiments are collected.

FIG. 41 is a diagram showing an example of a use case proposed by a TIP.

### DESCRIPTION OF EMBODIMENTS

### Basic Embodiment

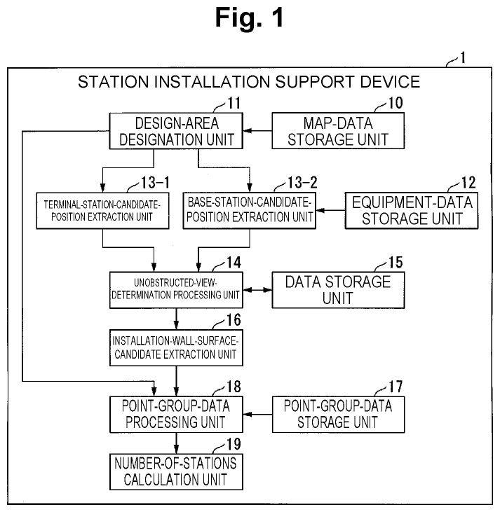

Embodiments of the present invention are explained below with reference to the drawings. FIG. 1 is a block diagram showing the configuration of a station installation support device 1 according to a basic embodiment. The station installation support device 1 includes a map-data storage unit 10, a design-area designation unit 11, an equipment-data storage unit 12, a terminal-station-candidate-position extraction unit 13-1, a base-station-candidate-position extraction unit 13-2, an unobstructed-view-determination processing unit 14, a data storage unit 15, an installation-wall-surface-candidate extraction unit 16, a point-group-data storage unit 17, a point-group-data processing unit 18, and a number-of-stations calculation unit 19.

First, data stored by the map-data storage unit 10, the equipment-data storage unit 12, the data storage unit 15, and the point-group-data storage unit 17 included in the station installation support device 1 are explained.

The map-data storage unit 10 stores two-dimensional map data. The map data includes data indicating positions and shapes of buildings to be candidates in which terminal stations are installed.

The equipment-data storage unit 12 stores base station candidate position data indicating the positions of base station installation structures, which are outdoor equipment such as utility poles to be candidates in which base stations are installed.

The data storage unit 15 stores, in association with identification data capable of identifying the individual base stations, data such as a processing result of unobstructed view determination of a building performed for each of the base stations by the unobstructed-view-determination processing unit 14.

The point-group-data storage unit 17 stores, for example, three-dimensional point group data acquired by an MMS.

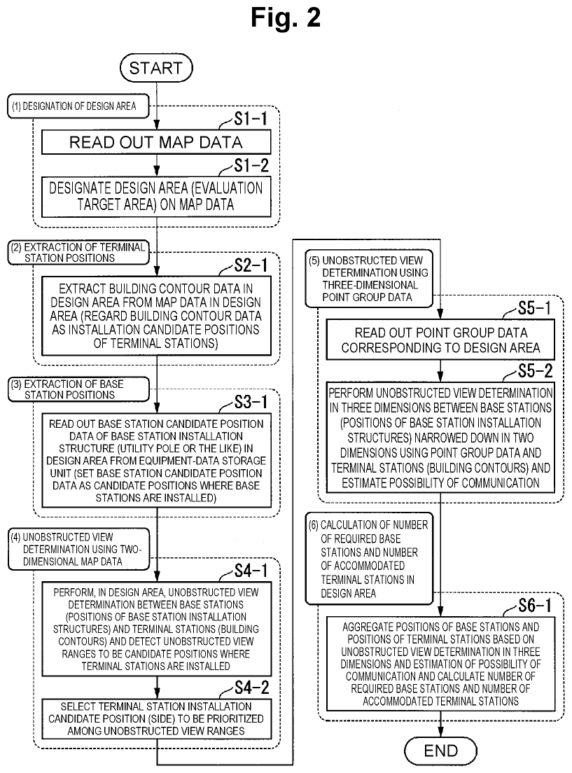

Configurations of the functional units of the station installation support device 1 and processing of a station installation support method by the station installation support device 1 are explained below with reference to a flowchart shown in FIG. 2.

The design-area designation unit 11 reads the two-dimensional map data from the map-data storage unit 10. The design-area designation unit 11 writes the read map data in, for example, a working memory and causes the working memory to store the read map data (step S1-1). The design-area designation unit 11 selects an appropriately decided rectangular area in the map data stored by the working memory. The design-area designation unit 11 designates the selected area as a design area.

The terminal-station-candidate-position extraction unit 13-1 extracts, from the map data in the design area, for each of the buildings, building contour data indicating the positions and the shapes of the buildings, that is, coordinates of contour lines of the building (step S2-1). The building contour data extracted by the terminal-station-candidate-position extraction unit 13-1 is data indicating wall surfaces of buildings in which the terminal stations are likely to be installed and is regarded as installation candidate positions of the terminal stations.

The building contour data includes data indicating coordinates of a plurality of vertexes included in the contour line of the building and data indicating an adjacency relation of the vertexes. The shape of the building can be specified by connecting the coordinates of the vertexes with a straight line based on the data indicating the adjacency relation of the vertexes. The coordinates of the vertexes of the building are, for example, coordinates indicated by values of an X coordinate and values of a Y coordinate in the case in which an orthogonal coordinate system having the horizontal axis as an X axis and having the vertical axis as a Y axis is applied to the map data included in the design area.

The terminal-station-candidate-position extraction unit 13-1 generates building identification data, which is identification information capable of uniquely identifying the individual buildings, and imparts the building identification data to the building contour data for each of the buildings to be extracted. The terminal-station-candidate-position extraction unit 13-1 outputs the imparted building identification data and the building contour data corresponding to the building in association with each other.

The base-station-candidate-position extraction unit 13-2 reads, from the equipment-data storage unit 12, base station candidate position data of base station installation structures located within a range of the design area designated by the design-area designation unit 11 (step S3-1). Note that, when coordinates of the map data stored by the map-data storage unit 10 and the base station candidate position data stored by the equipment-data storage unit 12 do not coincide, the base-station-candidate-position extraction unit 13-2 performs conversion for matching coordinates of the read base station candidate position data with a coordinate system of the map data.

The unobstructed-view-determination processing unit 14 determines, using the building contour data of each of the buildings output by the terminal-station-candidate-position extraction unit 13-1, an unobstructed view of each of the buildings from a position indicated by the base station candidate position data. The unobstructed-view-determination processing unit 14 refers to data indicating regions blocked by buildings having unobstructed views stored by the data storage unit 15 and excludes a region blocked by a building having an unobstructed view from the position indicated by the base station candidate position data and, then, performs the determination of an unobstructed view. The unobstructed-view-determination processing unit 14 detects, as an unobstructed view range, a range of a contour line having an unobstructed view in a building determined as having an unobstructed view (step S4-1).

The unobstructed-view-determination processing unit 14 detects the region blocked by the building having the unobstructed view from the position indicated by the base station candidate position data. The unobstructed-view-determination processing unit 14 writes data indicating the detected region blocked by the building having the unobstructed view in the data storage unit 15 and causes the data storage unit 15 to store the data. The unobstructed-view-determination processing unit 14 outputs, in association with each other, building identification data of the building determined as having the unobstructed view and data indicating a range of the unobstructed view detected in the building. The unobstructed view range detected by the unobstructed-view-determination processing unit 14 is an installation candidate position of the terminal stations.

The installation-wall-surface-candidate extraction unit 16 extracts candidates of wall surfaces on which the terminal stations can be installed among wall surfaces of the building corresponding to the unobstructed view range detected by the unobstructed-view-determination processing unit 14 (step S4-2).

The point-group-data processing unit 18 receives the data indicating the design area from the design-area designation unit 11 and reads point group data corresponding to the design area from the point-group-data storage unit 17 (step S5-1). The point-group-data processing unit 18 estimates possibility of communication by performing, based on data indicating the candidates of the wall surfaces on which the terminal stations can be installed in each of the buildings output by the installation-wall-surface-candidate extraction unit 16, using three-dimensional point group data, determination of unobstructed views between base stations having unobstructed views narrowed down in two dimensions and the terminal stations (step S5-2).

The number-of-stations calculation unit 19 aggregates the positions of the base stations and the positions of the terminal stations based on results of the unobstructed view determination and the estimation of possibility of communication performed using the three-dimensional point group data by the point-group-data processing unit 18 and calculates a required number of base stations and the number of accommodated terminal stations for each of the base stations (step S6-1).

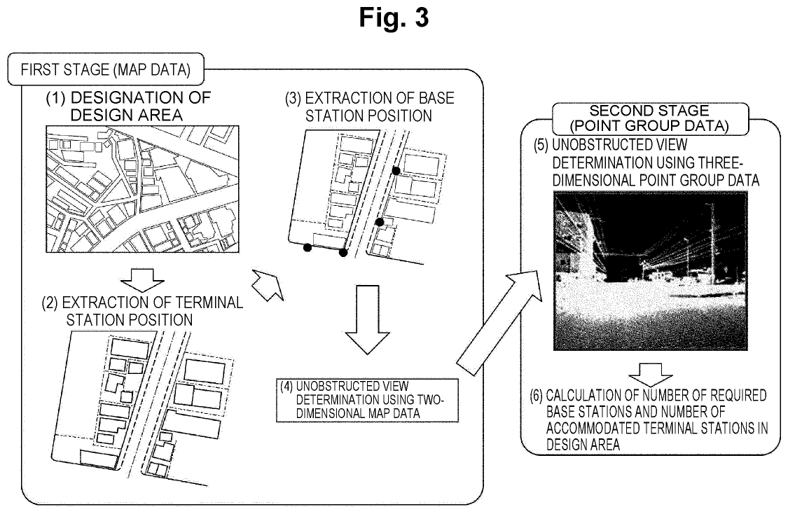

The configuration of the processing in the station installation support device 1 can also be grasped as processing in two stages, that is, processing performed using map data, which is two-dimensional data, as shown in FIG. 3 and processing performed using point group data, which is three-dimensional data, in response to a result of the processing.

As shown in FIG. 3, the processing performed using the map data, which is the two-dimensional data, in a first stage includes four kinds of processing of (1) designation of a design area, (2) extraction of terminal station positions, (3) extraction of base station positions, and (4) unobstructed view determination using two-dimensional map data.

(1) The processing of the designation of a design area is equivalent to the processing in steps S1-1 and S1-2 performed by the design-area designation unit 11. (2) The processing of the extraction of terminal station positions is equivalent to the processing in step S2-1 performed by the terminal-station-candidate-position extraction unit 13-1. (3) The processing of the extraction of base station positions is equivalent to the processing in step S3-1 performed by the base-station-candidate-position extraction unit 13-2. (4) The processing of the unobstructed view determination using two-dimensional map data is equivalent to the processing in steps S4-1 and S4-2 performed by the unobstructed-view-determination processing unit 14 and the installation-wall-surface-candidate extraction unit 16.

The processing performed using the point group data, which is the three-dimensional data, in a second stage includes two kinds of processing of (5) unobstructed view determination using three-dimensional point group data and (6) calculation of a required number of base stations and the number of accommodated terminal stations in the design area. (5) The processing of the unobstructed view determination using three-dimensional point group data is equivalent to the processing in steps S5-1 and S5-2 performed by the point-group-data processing unit 18. (6) The processing of the calculation of a required number of base stations and the number of accommodated terminal stations in the design area is equivalent to the processing in step S6-1 performed by the number-of-stations calculation unit 19.

In the configuration in the basic embodiment explained above, the unobstructed-view-determination processing unit 14 sets, in two-dimensional map data showing buildings to be candidates in which terminal stations are installed, as base station candidate positions, positions of base station installation structures to be candidates in which base stations are installed, determines, based on the map data, an unobstructed view of each of the buildings from a position indicated by base station candidate position data while excluding regions blocked by buildings having unobstructed views from the base station candidate positions, and detects, as an unobstructed view range, a range of a contour line having an unobstructed view of the building determined as having an unobstructed view. The installation-wall-surface-candidate extraction unit 16 extracts candidates of wall surfaces on which the terminal stations can be installed among wall surfaces of the building corresponding to the unobstructed view range detected by the unobstructed-view-determination processing unit 14. The point-group-data processing unit 18 performs, using information concerning the wall surfaces extracted by the installation-wall-surface-candidate extraction unit 16, narrowing-down of three-dimensional point group data obtained by taking an image of a region including the base station installation structures and the buildings and determines, using the narrowed-down point group data, an unobstructed view to the building from the position indicated by the base station candidate position data. Consequently, before processing the three-dimensional point group data, when evaluating an unobstructed view using the two-dimensional map data, it is possible to narrow down the number of evaluation target buildings.

In first to fifth embodiments explained below, other configuration examples of the unobstructed-view-determination processing unit 14 are explained. In a sixth embodiment, another configuration example of the installation-wall-surface-candidate extraction unit 16 is explained.

### First Embodiment

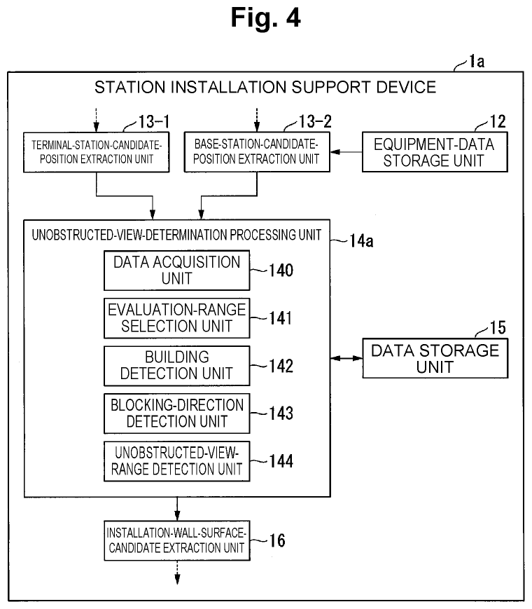

FIG. 4 is a block diagram showing the configuration of a station installation support device 1a according to a first embodiment. In the first embodiment, the same components as the components in the basic embodiment are denoted by the same reference numeral and signs. Different components are explained below. The station installation support device 1a has a configuration in which the unobstructed-view-determination processing unit 14 is replaced with an unobstructed-view-determination processing unit 14a in the station installation support device 1 in the basic embodiment.

The unobstructed-view-determination processing unit 14a includes a data acquisition unit 140, an evaluation-range selection unit 141, a building detection unit 142, a blocking-direction detection unit 143, and an unobstructed-view-range detection unit 144.

The data acquisition unit 140 captures base station candidate position data extracted and output by the base-station-candidate-position extraction unit 13-2 and building contour data of each of buildings extracted and output by the terminal-station-candidate-position extraction unit 13-1.

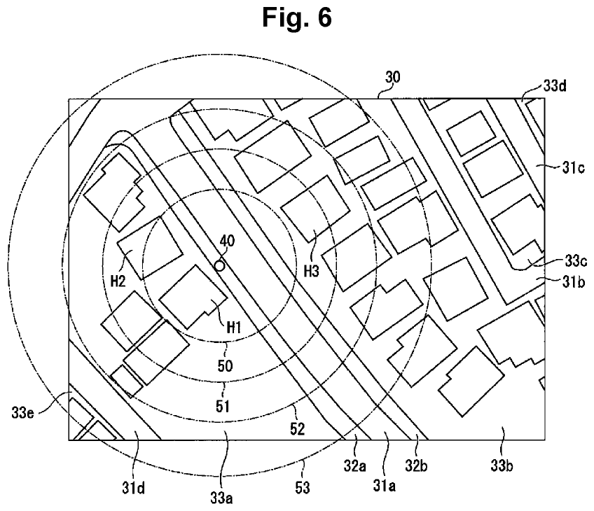

The evaluation-range selection unit 141 selects, as an evaluation range of unobstructed view determination, a range that is centered on a position indicated by the base station candidate position data extracted by the base-station-candidate-position extraction unit 13-2, and is to be expanded stepwise. For example, as shown in FIG. 6, the evaluation-range selection unit 141 selects circular evaluation ranges 50, 51, 52, and 53, the radiuses of which are increased stepwise around the position of a utility pole 40 present in the position indicated by the base station candidate position data.

The building detection unit 142 detects, for each of the evaluation ranges 50, 51, . . . in stages selected by the evaluation-range selection unit 141, buildings partially or entirely included in the evaluation ranges 50, 51, . . . . The blocking-direction detection unit 143 detects a range of a blocking direction blocked by the unobstructed view range detected by the unobstructed-view-range detection unit 144.

The unobstructed-view-range detection unit 144 detects, for example, with the method described in Patent Literature 1, a range of a contour line having an unobstructed view of a building detected by the building detection unit 142. The unobstructed-view-range detection unit 144 detects the detected range of the contour line as an unobstructed view range of the building. When an entire unobstructed view detection target building is included in a range of a blocking direction, the unobstructed-view-range detection unit 144 excludes the building from detection targets of a contour line having an unobstructed view.

### (Processing by the Station Installation Support Device in the First Embodiment)

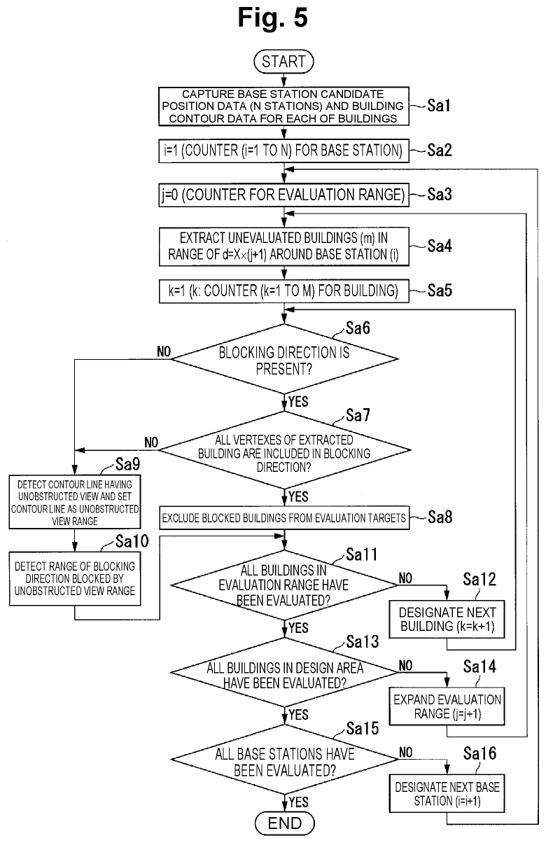

Processing of the station installation support device 1a is explained with reference to FIGS. 5 to 9. FIG. 5 is a flowchart showing a flow of processing of a station installation support method by the station installation support device 1a.

The data acquisition unit 140 of the unobstructed-view-determination processing unit 14a captures base station candidate position data output by the base-station-candidate-position extraction unit 13-2 and building contour data for each of buildings output by the terminal-station-candidate-position extraction unit 13-1 (step Sa1). It is assumed that the data acquisition unit 140 captures N base station candidate position data. It is assumed that the data acquisition unit 140 captures building contour data of L buildings.

The data acquisition unit 140 sets a counter “i” as a variable for counting base station candidate position data to be evaluated and substitutes “1” in “i” as an initial value (step Sa2).

The evaluation-range selection unit 141 sets a counter “j” as a variable for counting how many times an evaluation range is expanded and substitutes “0” in “j” as an initial value (step Sa3).

The evaluation-range selection unit 141 sets, around a position indicated by a “i=1”-th base station candidate position data, a circular region having a radius d as an evaluation range of unobstructed view determination. It is assumed that d=X×(j+1) and X is a value determined in advance.

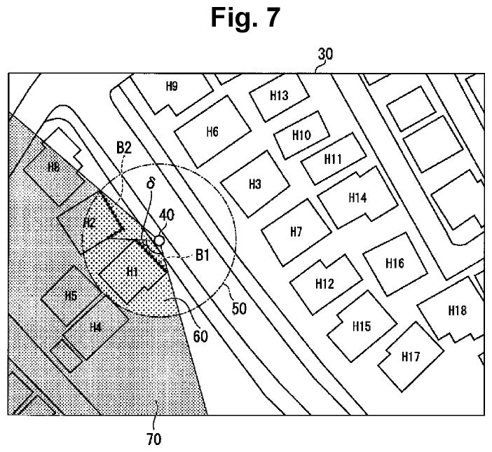

Map data 30 shown in FIG. 6 to FIG. 9 are map data obtained by segmenting a region included in a design area designated by the design-area designation unit 11 from map data stored by the map-data storage unit 10. As shown in FIG. 6, in the map data 30, for example, roads 31a, 31b, 31c, and 31d, sidewalks 32a and 32b, sections 33a, 33b, 33c, 33d, and 33e where buildings are set, and the utility pole 40 are shown. In each of the sections 33a, 33b, 33c, 33d, and 33e, for example, contour lines indicating the shapes of buildings H1, H2, H3, and the like are shown. Note that, in FIG. 7 to FIG. 9, signs H1, H2, and the like indicating the buildings are shown on the insides of the contour lines of the buildings from the viewpoint of easiness to see the drawings. The signs are attached to only the buildings necessary for explanation. In the figures other than FIG. 7 to FIG. 9, signs are also shown in the same manner from the viewpoint of easiness to see the drawings.

It is assumed that a position indicated by i=1-th base station candidate position data is the position of the utility pole 40 in the map data 30. For example, in the case of j=0, as shown in FIG. 7, the evaluation-range selection unit 141 sets, in the map data 30, a circular evaluation range 50 having a radius d=X around the position of the utility pole 40.

The building detection unit 142 detects buildings partially or entirely included in the evaluation range 50 and counts a number M of the remaining buildings excluding evaluated buildings, that is, unevaluated buildings (step Sa4). In the case of the evaluation range 50, as shown in FIG. 7, a building is absent in a region other than a region 60 in the evaluation range 50. The building detection unit 142 detects two buildings, that is, a building H1 entirely included in the region 60 and a building H2 partially included in the region 60. Accordingly, the building detection unit 142 sets M=2.

The unobstructed-view-range detection unit 144 sets a counter “k” as a variable for counting buildings in order to perform evaluation of an unobstructed view for each of the buildings detected by the building detection unit 142 and substitutes “1” in “k” as an initial value. The unobstructed-view-range detection unit 144 selects, as a k=1-th building, any one of the buildings extracted in step Sa4. It is assumed that the unobstructed-view-range detection unit 144 selects the building H1 (step Sa5).

The unobstructed-view-range detection unit 144 refers to the data storage unit 15 and determines whether a blocking direction is present (step Sa6). Since a blocking direction is absent, the data storage unit 15 does not store data of a blocking direction. Accordingly, the unobstructed-view-range detection unit 144 determines that a blocking direction is absent (step Sa6—No).

The unobstructed-view-range detection unit 144 detects, based on building contour data of the “k=1”-th building H1 and the position of the utility pole 40, using the method described in Patent Literature 1, a line segment B1, which is a portion of a contour line having an unobstructed view. The unobstructed-view-range detection unit 144 detects the detected line segment B1 as an unobstructed view range of the building H1. The unobstructed-view-range detection unit 144 writes data indicating the detected unobstructed view range of the building H1 in the data storage unit 15 in association with building identification data of the building H1 and causes the data storage unit 15 to store the data (step Sa9). For example, when a line segment of the unobstructed view range is a straight line, the data indicating the unobstructed view range is data indicating a coordinate of a start point and data indicating a coordinate of an end point. Note that, when a vertex of a building is present between the start point and the end point, the data indicating the unobstructed view range further includes data indicating a coordinate of the vertex and data indicating an adjacency relation among the start point, the end point, and the vertex.

The blocking-direction detection unit 143 detects, around the position of the utility pole 40, a direction of a line segment connecting the position of the utility pole 40 and one end of the line segment B1 to a direction of a line segment connecting the position of the utility pole 40 and the other end of the line segment B1 as a range of a blocking direction blocked by the building H1 having an unobstructed view. In FIG. 7, an angle formed by the range of the blocking direction with the building H1 having the unobstructed view is set to an angle δ. The blocking-direction detection unit 143 writes data indicating the detected range of the blocking direction in the data storage unit 15 and causes the data storage unit 15 to store the data (step Sa10).

The unobstructed-view-range detection unit 144 determines whether all the buildings in the evaluation range 50 have been evaluated. That is, the unobstructed-view-range detection unit 144 determines whether k is equal to or larger than M (step Sa11). Since k=1 and M=2, the unobstructed-view-range detection unit 144 determines that k is not equal to or larger than M (step Sa11—No). The unobstructed-view-range detection unit 144 adds 1 to k and selects the building H2, which is the next building (step Sa12).

The unobstructed-view-range detection unit 144 refers to the data storage unit 15 and determines whether a blocking direction is present (step Sa6). The data storage unit 15 stores the data indicating the range of the blocking direction blocked by the building H1. Accordingly, the unobstructed-view-range detection unit 144 determines that the blocking direction is present (step Sa6—Yes).

The unobstructed-view-range detection unit 144 determines whether coordinates of coordinates of all vertexes included in building contour data of the building H2 are included in the range of the blocking direction (step Sa7). As shown in FIG. 7, not all of vertexes of the building H2 are included in the range of the blocking direction by the building H1. Accordingly, the unobstructed-view-range detection unit 144 determines that the coordinates of all of the vertexes of the building H2 are not included in the range of the blocking direction (step Sa7—No).

The unobstructed-view-range detection unit 144 detects, in the building H2, a line segment B2, which is a portion of a contour line having an unobstructed view not included in the range of the blocking direction. The unobstructed-view-range detection unit 144 detects the detected line segment B2 as an unobstructed view range of the building H2. The unobstructed-view-range detection unit 144 writes data indicating the detected unobstructed view range of the building H2 in the data storage unit 15 in association with building identification data of the building H2 and causes the data storage unit 15 to store the data (step Sa9).

The blocking-direction detection unit 143 detects, based on the line segment B2 detected by the unobstructed-view-range detection unit 144, a range of a blocking direction blocked by the building H2 having an unobstructed view. The blocking-direction detection unit 143 writes data indicating the detected range of the blocking direction in the data storage unit 15 and causes the data storage unit 15 to store the data (step Sa10).

At this time, a region other than the evaluation range 50, the region being included in a range of a blocking direction by the buildings H1 and H2 having the unobstructed views stored by the data storage unit 15, is a region 70.

The unobstructed-view-range detection unit 144 determines whether all the buildings in the evaluation range 50 have been evaluated (step Sa11). Since k=2 and M=2, the unobstructed-view-range detection unit 144 determines that k is equal to or larger than M (step Sa11—Yes). The evaluation-range selection unit 141 determines whether all the buildings, that is, the L buildings in the design area have been evaluated (step Sa13).

Specifically, the building detection unit 142 stores, in a storage region on the inside, a total value of a number M of buildings detected every time the processing in step Sa4 is performed. If the total value of the number M of buildings is smaller than L, the evaluation-range selection unit 141 determines that the L buildings are not evaluated. On the other hand, if the total value of the number M of buildings is equal to or larger than L, the evaluation-range selection unit 141 determines that the L buildings have been evaluated.

The evaluation-range selection unit 141 determines that not all of the buildings in the design area have been evaluated (step Sa13—No). The evaluation-range selection unit 141 adds 1 to j (step Sa14).

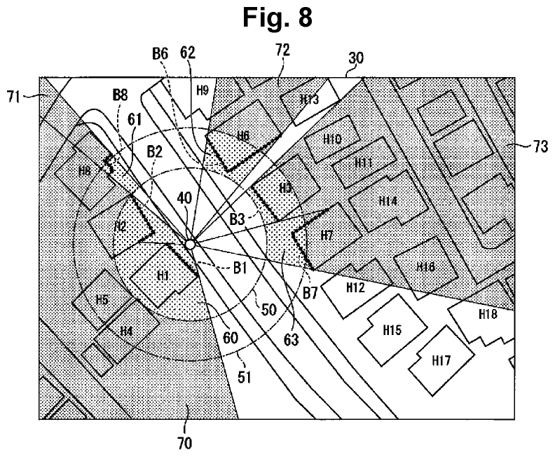

As shown in FIG. 8, the evaluation-range selection unit 141 sets, as the evaluation range 51 of unobstructed view determination, a circular region having a radius d=2X around a position indicated by “i=1”-th base station candidate position data.

The building detection unit 142 detects buildings partially or entirely included in the evaluation range 51 and counts the number M of the remaining buildings excluding evaluated buildings, that is, unevaluated buildings (step Sa4). In the case of the evaluation range 51, as shown in FIG. 8, the building detection unit 142 detects buildings H1, H2, H4, H5, H8, H6, H3, and H7 as the buildings partially or entirely included in the evaluation range 51. Among the buildings, since the buildings H1 and H2 are already evaluated, the building detection unit 142 excludes the buildings H1 and H2. The building detection unit 142 counts the number of the remaining buildings H4, H5, H8, H6, H3, and H7 as M=6. Thereafter, for each of the building H4, H5, H8, H6, H3, and H7, the processing in steps Sa6 to Sa12 is repeatedly performed.

In the case of the buildings H4 and H5, coordinates of all vertexes of the shapes of the buildings H4 and H5 are included in the region 70 included in a range of a blocking direction. Accordingly, the unobstructed-view-range detection unit 144 determines Yes in step Sa7 and excludes the buildings H4 and H5 from evaluation targets in step Sa8.

In the case of the building H8, coordinates of a part of vertexes of the shape of the building H8 are included in the region 70 included in the range of the blocking direction. However, a part of the vertexes are also present in a region 61 not included in the range of the blocking direction. Accordingly, the unobstructed-view-range detection unit 144 determines No in step Sa7. In step Sa9, the unobstructed-view-range detection unit 144 detects a line segment B8, which is a portion of a contour line having an unobstructed view of the building H8 not included in the range of the blocking direction and detects the line segment B8 as an unobstructed view range of the building H8. The unobstructed-view-range detection unit 144 writes data indicating the detected unobstructed view range of the building H8 in the data storage unit 15 in association with building identification data of the building H8 and causes the data storage unit 15 to store the data.

In step Sa10, the blocking-direction detection unit 143 detects, based on the line segment B8 detected by the unobstructed-view-range detection unit 144, a range of a blocking direction blocked by the building H8 having an unobstructed view. The blocking-direction detection unit 143 writes data indicating the detected range of the blocking direction in the data storage unit 15 and causes the data storage unit 15 to store the data.

The buildings H6, H3, and H7 are not present in the range of the blocking direction by the buildings H1, H2, and H3 having the unobstructed views. Accordingly, the unobstructed-view-range detection unit 144 determines No in step Sa1. In step Sa9, as in the case of the buildings H1 and H2, the unobstructed-view-range detection unit 144 detects a line segment B6, which is a portion of a contour line having an unobstructed view of the building H6, in a region 62 included in the evaluation range 51. The unobstructed-view-range detection unit 144 detects the detected line segment B6 as an unobstructed view range of the building H6. The unobstructed-view-range detection unit 144 detects line segments B3 and B7, which are portions of contour lines having unobstructed views of the buildings H3 and H7, in a region 63 included in the evaluation range 51. The unobstructed-view-range detection unit 144 detects the respective detected line segments B3 and B7 as unobstructed view ranges of the buildings H3 and H7. The unobstructed-view-range detection unit 144 writes each of data indicating the detected unobstructed view ranges of the buildings H6, H3, and H7 in the data storage unit 15 in association with building identification data of the buildings H6, H3, and H7 and causes the data storage unit 15 to store the data.

In step Sa10, the blocking-direction detection unit 143 detects, based on the buildings H6, H3, and H7 detected by the unobstructed-view-range detection unit 144, a range of a blocking direction blocked by the buildings H6, H3, and H7 having the unobstructed views. The blocking-direction detection unit 143 writes data indicating the detected range of the blocking direction in the data storage unit 15 and causes the data storage unit 15 to store the data.

At this time, a region other than the evaluation ranges 50 and 51, the region being included in the range of the blocking direction by the building H8 having the unobstructed view stored by the data storage unit 15, is a region 71. The region being included in the range of the blocking direction by the building H6 having the unobstructed view is a region 72. A region included in the range of the blocking direction by the buildings H3 and H7 having the unobstructed views is a region 73.

When evaluation of all the buildings ends in the evaluation range 51, the evaluation-range selection unit 141 adds 1 to j in step Sa14 and sets the evaluation range 52 having a radius d=3X in step Sa4. Thereafter, the processing in steps Sa6 to Sa12 is repeatedly performed.

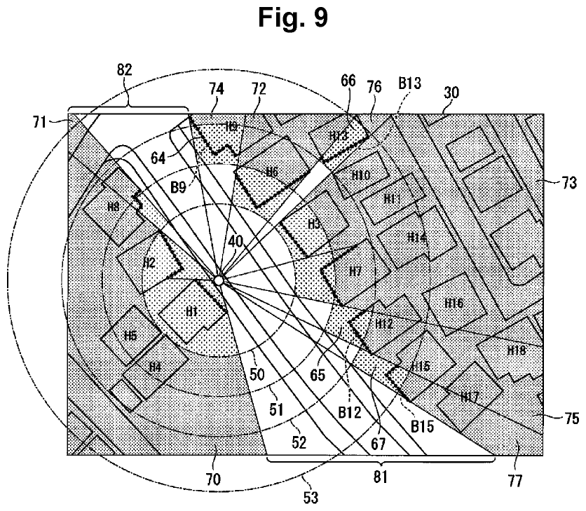

FIG. 9 is a diagram showing an unobstructed view range at a stage when the evaluation range 53 having a radius d=4X is set and a region included in a range of a blocking direction. Note that, in FIG. 9, to avoid complication of content, a part of the signs shown in FIG. 8 are omitted.

As shown in FIG. 9, by expanding the range of the evaluation range 51 to ranges of the evaluation ranges 52 and 53, the unobstructed-view-range detection unit 144 further detects line segments B9, B12, B13, and B15, which are unobstructed view ranges of the buildings H9, H12, H13, and H15, in regions 64 and 65 included in the evaluation range 52 and regions 66 and 67 included in the evaluation range 53.

Consequently, the unobstructed-view-range detection unit 144 detect the line segments B1, B2, B8, B6, B3, B7, B9, B12, B13, and B15, which are the unobstructed view ranges of the ten buildings H1, H2, H8, H6, H3, H7, H9, H12, H13, and H15 in total. Ranges in blocking directions blocked by the respective line segments B1, B2, B8, B6, B3, B7, B9, B12, B13, and B15 of the buildings having the unobstructed views detected by the blocking-direction detection unit 143 are regions 70 to 77. Note that, in FIG. 9, since buildings are absent in ranges indicated by a sign 81 and a sign 82, the ranges are unblocked ranges.

At this stage, all of the remaining buildings are included in the regions 70 to 77. Even if an evaluation range increases, the unobstructed-view-range detection unit 144 determines Yes in the processing in step Sa1 for all of the remaining buildings and excludes the remaining buildings from targets of evaluation in step Sa8.

When the evaluation-range selection unit 141 determines in step Sa13 that all the L buildings have been evaluated (step Sa13—Yes), the data acquisition unit 140 determines whether all the base stations have been evaluated. That is, the data acquisition unit 140 determines whether i is equal to or larger than N (step Sa15). When determining that i not is equal to or larger than N (step Sa15—No), the data acquisition unit 140 adds 1 to i and selects the next base station candidate position data (step Sa16). Thereafter, processing in step Sa3 and subsequent steps is performed. On the other hand, when determining that i is equal to or larger than N (step Sa15—Yes), the data acquisition unit 140 ends the processing.

Note that, when the processing is advanced to step Sa16, data such as an unobstructed view range for each of the buildings corresponding to the “i=1”-th base station candidate position data is stored in the data storage unit 15. Accordingly, the data is copied to another storage region as data corresponding to the “i=1”-th base station candidate position data. The data storage unit 15 is initialized.

In the unobstructed-view-determination processing unit 14a in the first embodiment explained above, the evaluation-range selection unit 141 selects, as an evaluation range of unobstructed view determination, a range that is centered on a position indicated by base station candidate position data, and is to be expanded stepwise. The building detection unit 142 detects, for each of evaluation ranges at stages selected by the evaluation-range selection unit 141, a building partially or entirely included in the evaluation range. The unobstructed-view-range detection unit 144 detects a range of contour lines having unobstructed views of the building detected by the building detection unit 142 and detects the detected range of the contour lines as an unobstructed view range of the building. The blocking-direction detection unit 143 detects a range of a blocking direction blocked by the unobstructed view range detected by the unobstructed-view-range detection unit 144. When an entire unobstructed view determination target building is included in the range of the blocking direction, the unobstructed-view-range detection unit 144 excludes the building from detection targets of a contour line having an unobstructed view.

With the configuration in the first embodiment, before performing enormous processing of unobstructed view determination between base stations and terminal stations by large-volume three-dimensional point group data information, it is possible to narrow down, on a map, candidates of buildings in which the terminal stations are installed. Since the candidates of the buildings in which the terminal stations are installed are narrowed down, it is possible to greatly reduce the determination processing with the point group data information. In processing for narrowing down, on map data, the candidates of the buildings in which the terminal stations are installed, not all of the buildings have to be evaluated one by one. That is, the buildings to be evaluated are limited to the evaluation range that expands stepwise and the buildings present in the range of the blocking direction in which unobstructed views from the base stations are blocked by the unobstructed view ranges of the buildings having the unobstructed views are excluded from the evaluation targets. Therefore, it is possible to efficiently perform the detection of the unobstructed view range.

In the first embodiment explained above, in step Sa13, when the remaining buildings that need to be evaluated are present, the evaluation-range selection unit 141 may further determine whether the remaining buildings are included in the range of the blocking direction blocked by the buildings having the unobstructed views. In this way, when all of the remaining buildings are included in the range of the blocking direction blocked by the buildings having the unobstructed views, the evaluation-range selection unit 141 may determine Yes in step Sa13 and advances the processing to step Sa15. Consequently, it is possible to achieve a reduction in a processing amount.

In the first embodiment explained above, in the case of the evaluation range 52, the processing for setting all the buildings included in the inside of the evaluation range 52 as evaluation targets and, in step Sa4, excluding the evaluated buildings is performed. However, processing for setting buildings included in a region between the evaluation range 51 and the evaluation range 52 as evaluation targets and, then, excluding the evaluated buildings may be performed. Consequently, it is possible to reduce the number of evaluation target buildings. Therefore, it is also possible to reduce the number of buildings to be excluded.

### Second Embodiment

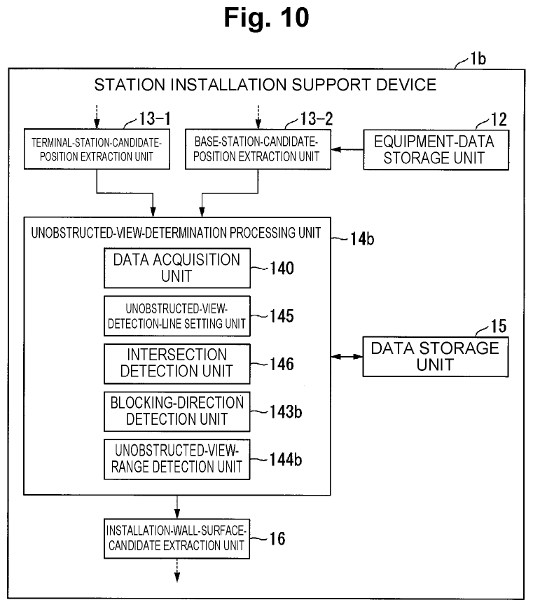

FIG. 10 is a block diagram showing the configuration of a station installation support device 1b according to a second embodiment. In the second embodiment, the same components as the components in the basic embodiment and the first embodiment are denoted by the same reference numerals and signs. Different components are explained below. The station installation support device 1b has a configuration in which the unobstructed-view-determination processing unit 14 is replaced with an unobstructed-view-determination processing unit 14b in the station installation support device 1 in the basic embodiment.

The unobstructed-view-determination processing unit 14b includes the data acquisition unit 140, an unobstructed-view-detection-line setting unit 145, an intersection detection unit 146, a blocking-direction detection unit 143b, and an unobstructed-view-range detection unit 144b. The unobstructed-view-detection-line setting unit 145 sets an unobstructed view detection line having a predetermined line length starting from a position indicated by base station candidate position data and rotates the unobstructed view detection line in one direction. The unobstructed-view-detection-line setting unit 145 increases the line length of the unobstructed view detection line stepwise and rotates the unobstructed view detection line, the line length of which is increased, in one direction.

The intersection detection unit 146 detects an intersection of the unobstructed view detection line and a contour line of a building, the intersection being an intersection at the shortest distance from the position indicated by the base station candidate position data to the intersection. The intersection detection unit 146 detects intersection data indicating a coordinate of the detected intersection, building identification data indicating a building in which the intersection is present, line segment identification data indicating in which contour line of the building the intersection is present, and direction data indicating a direction of the unobstructed view detection line. Note that, when the position of the intersection coincides with a vertex of the building, two line segment identification data respectively indicating two sides of the building sharing the vertex are associated with the intersection. When an intersection corresponding to the direction of the unobstructed view detection line is detected or when the direction of the unobstructed view detection line is included in a blocking direction detected by the blocking-direction detection unit 143b, the intersection detection unit 146 does not perform detection of an intersection.

The unobstructed-view-range detection unit 144b extracts a combination of intersection data in which building identification data is the same and line segment identification data is the same. The unobstructed-view-range detection unit 144b generates a line segment that connects coordinates of the intersection data included in the extracted combination. The unobstructed-view-range detection unit 144b detects the generated line segment as an unobstructed view range of a building corresponding to the building identification data.

The blocking-direction detection unit 143b detects a range of a blocking direction blocked by the unobstructed view range detected by the unobstructed-view-range detection unit 144b.

### (Processing by the Station Installation Support Device in the Second Embodiment)

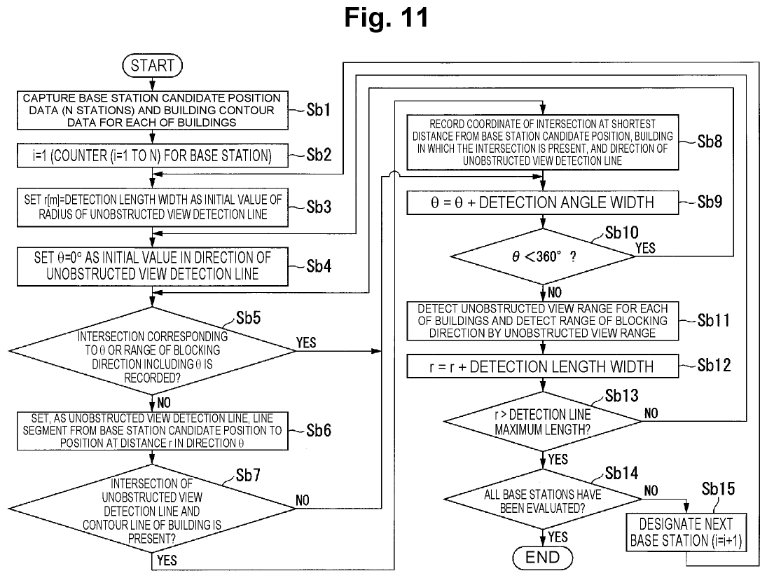

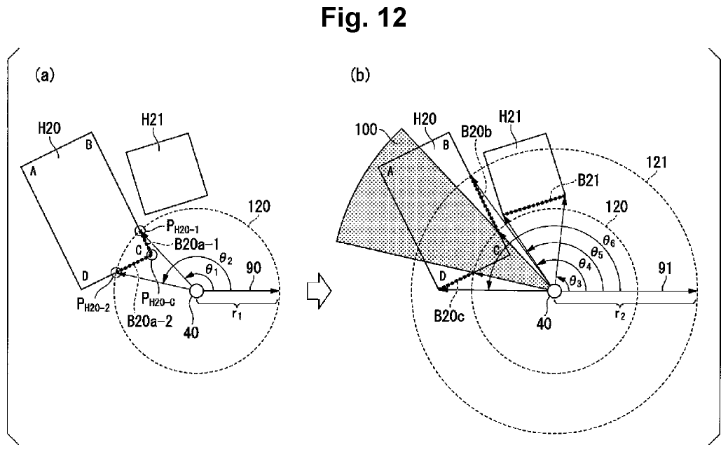

Subsequently, processing by the station installation support device 1b in the second embodiment is explained with reference to FIG. 11 and FIG. 12. FIG. 11 is a flowchart showing a flow of processing of a station installation support method by the station installation support device 1b.

About step Sb1 and step Sb2, the same processing as the processing in step Sa1 and step Sa2 in the first embodiment is performed by the data acquisition unit 140.

The unobstructed-view-detection-line setting unit 145 sets a predetermined detection length width as an initial value of a radius r of an unobstructed view detection line (step Sb3). The unobstructed-view-detection-line setting unit 145 sets “0°” as an initial value of an angle θ in the direction of the unobstructed view detection line (step Sb4). The direction of “0°” is, for example, a rightward horizontal direction as shown in FIGS. 12(a) and 12(b).

The unobstructed-view-detection-line setting unit 145 refers to the data storage unit 15 and determines whether intersection data with respect to a direction of θ is recorded or a range of a blocking direction including θ is recorded (step Sb5). Neither the intersection data nor the range of the blocking direction is recorded in the data storage unit 15. Accordingly, the unobstructed-view-detection-line setting unit 145 determines that the intersection data with respect to the direction of θ is not recorded and the range of the blocking direction including θ is not recorded either (step Sb5—No).

The unobstructed-view-detection-line setting unit 145 sets, as an unobstructed view detection line, a line segment to a position of a distance r toward the direction of θ from the position indicated by the base station candidate position data (step Sb6). For example, as shown in FIG. 12(a), the unobstructed-view-detection-line setting unit 145 sets an unobstructed view detection line 90 having a radius “r₁” in the horizontal direction starting from the position of the utility pole 40 on map data of a design area designated by the design-area designation unit 11. The position of the utility pole 40 is a position indicated by the “i=1”-th base station candidate position data. The radius “r1” is an initial value of a radius of an unobstructed view detection line, that is, length of a detection length width.

The intersection detection unit 146 determines, based on building contour data output by the terminal-station-candidate-position extraction unit 13-1, whether a intersection of the unobstructed view detection line 90 and a contour line of a building is present (step Sb7). As shown in FIG. 12(a), in the case of θ=0°, an intersection with a contour line of a building is absent. Accordingly, the intersection detection unit 146 determines that an intersection of the unobstructed view detection line 90 and a contour line of a building is absent (step Sb7—No).

The unobstructed-view-detection-line setting unit 145 sets, as new θ, an angle obtained by adding a predetermined detection angle width to θ (step Sb9). The unobstructed-view-detection-line setting unit 145 determines whether new θ is smaller than 360° (step Sb10). When determining that new θ is smaller than 360° (step Sb10—Yes), the unobstructed-view-detection-line setting unit 145 advances the processing to step Sb5.

For example, when a detection angle width is assumed to be “0.1°”, new θ is “0+0.1=0.1°”. Accordingly, the unobstructed-view-detection-line setting unit 145 determines Yes in step Sb10. The unobstructed-view-detection-line setting unit 145 performs the processing in step Sb5. The processing in step Sb5 (a determination result: No), step Sb6, step Sb7 (a determination result: No), step Sb9, and step Sb10 (a determination result: Yes) is repeatedly performed. When θ changes to θ₁ shown in FIG. 12(a), in step Sb7, the intersection detection unit 146 determines that an intersection of the unobstructed view detection line 90 and a contour line of a building H20 is present (step Sb7—Yes).

A method in which the intersection detection unit 146 determines, using coordinates of vertexes of a building included in building contour data, whether an intersection is present in the unobstructed view detection line 90 and a contour line of the building H20 is explained. Note that the method explained below is a method based on content described in a reference document described below.
Reference document: Nobuki Hiramae, “An Intersection of Two Line Segments”, [searched on Aug. 14, 2019], Internet (URL: https://www.hiramine.com/programming/graphics/2d_segmentintersection.html)

For example, four vertexes of the building H20 are represented as A, B, C, and D. A line segment between the vertex B and the vertex C is hereinafter referred to as line segment BC. A coordinate of any point U on the line segment BC is represented as the following Expression (1) using a parameter ψ, a coordinate of the vertex B, and a coordinate of the vertex C.

Coordinate of U=coordinate of B+ψ×(coordinate of B−coordinate of C) (1)

On the other hand, a coordinate of any point V on the unobstructed view detection line 90 is represented as the following Expression (2) using a parameter ω, a coordinate of a start point of the unobstructed view detection line 90, and a coordinate of an end point of the unobstructed view detection line 90.

Coordinate of V=coordinate of the start point+Ω×(coordinate of the end point−coordinate of the start point) (2)

If Expression (1) and Expression (2) are equal, that is, the coordinate of U and the coordinate of V coincide and both of the parameters ψ and ω are values between 0 and 1, the line segment BC and the unobstructed view detection line 90 cross. A coordinate of an intersection of the line segment BC and the unobstructed view detection line 90 is the coordinate of U (=the coordinate of V).

When determining that an intersection is present, the intersection detection unit 146 detects intersection data indicating a coordinate of the intersection, building identification data of a building in which the intersection is present, line segment identification data indicating in which contour line of the building the intersection is present, and direction data indicating a direction of an unobstructed view detection line. The line segment identification data is, for example, data obtained by combining, such that a position of a side of the shape of the building in which the intersection is present is seen, coordinate data of vertexes of a start point and an end point of the side.

When a plurality of intersections are detected by the unobstructed view detection line 90 directed to certain one direction, the intersection detection unit 146 detects, as an intersection having an unobstructed view, an intersection at the shortest distance from the position indicated by the base station candidate position data, that is, the position of the utility pole 40. For example, when the unobstructed view detection line 90 crosses contour lines of one building or a plurality of buildings at a plurality of intersections, an intersection at the shortest distance from the utility pole 40 is an intersection having an unobstructed view when viewed from the utility pole 40. In contrast, an intersection other than the intersection having the unobstructed view is an intersection not having an unobstructed view because the intersection is located behind the intersection having the unobstructed view. Accordingly, the intersection detection unit 146 detects, as an intersection having an unobstructed view, an intersection at the shortest distance from the position of the utility pole 40.

It is assumed that the intersection detection unit 146 detects an intersection P_{H20-1} shown in FIG. 12(a) as the intersection at the shortest distance from the position of the utility pole 40. The intersection detection unit 146 writes intersection data indicating a coordinate of the intersection P_{H20-1}, building identification data of the building H20 in which the intersection P_{H20-1} is present, line segment identification data indicating sides of the vertex B and the vertex C of the building H20 in which the intersection P_{H20-1} is present, and direction data indicating an angle θ₁ of the direction of the unobstructed view detection line 90 in the data storage unit 15 and causes the data storage unit 15 to store the data (step Sb8).

It is assumed that, thereafter, the processing in step Sb5 (a determination result: No), step Sb6, step Sb7 (a determination result: Yes), step Sb8, step Sb9, step Sb10 (a determination result: Yes) is repeatedly performed and, the direction of the unobstructed view detection line 90 changes from θ₁ to θ₂. During the change, in step Sb8, the intersection detection unit 146 detects a coordinate of an intersection at the shortest distance from the utility pole 40 in each direction between θ₁ and θ₂ and writes intersection data of the detected intersection, building identification data of the building H20, and line segment identification data and direction data corresponding to the intersection in the data storage unit 15 and causes the data storage unit 15 to store the data.

When θ is 360° or more, the unobstructed-view-detection-line setting unit 145 determines that θ is not smaller than 360° (step Sb10—No). The unobstructed-view-range detection unit 144b refers to the data storage unit 15 and performs detection of an unobstructed view range for each building.

When the unobstructed-view detection line 90 having the radius “r₁” rotates once, a track of the end point of the unobstructed view detection line 90 becomes a circle 120. At this stage, a plurality of intersection data concerning the building H20 in a range of a direction from θ₁ to θ₂ are stored in the data storage unit 15. The unobstructed-view-range detection unit 144b reads, from the data storage unit 15, intersection data coinciding with the building identification data of the building H20 and line segment identification data and direction data corresponding to the intersection data.

### (Generation of a Line Segment to be an Unobstructed View Range)

The unobstructed-view-range detection unit 144b generates a line segment to be an unobstructed view range according to a method explained below. The unobstructed-view-range detection unit 144b selects intersection data coinciding with the line segment identification data from the read intersection data. The unobstructed-view-range detection unit 144b further selects, from the selected intersection data, two intersection data, that is, intersection data in which a value of an X coordinate is a maximum value and intersection data in which a value of an X coordinate is a minimum value. The unobstructed-view-range detection unit 144b generates a line segment connecting coordinates of the selected two intersection data. Since the line segment identification data coincides with the line segment, the line segment is a line segment along a contour line of the building. When the values of the X coordinates are the same values, the unobstructed-view-range detection unit 144b selects two intersection data, that is, intersection data in which a value of a Y coordinate is a maximum value and intersection data in which a value of a Y coordinate is a minimum value and detects a line segment connecting coordinates of the two intersection data as an unobstructed view range.

For example, in the case of FIG. 12(a), it is assumed that a positive direction of the X coordinate is the rightward horizontal direction and a positive direction of the Y coordinate is the upward vertical direction. Based on the read intersection data and the read line segment identification data of the building H20, the unobstructed-view-range detection unit 144b selects an intersection P_{H20-c} as intersection data in which an X coordinate is a maximum value among intersection data coinciding with line segment identification data indicating the line segment between the vertex B and the vertex C of the building H20 and selects the intersection P_{H20-1} as intersection data in which an X coordinate is a minimum value among the intersection data. It is assumed that the intersection P_{H20-c} is a point coinciding with the vertex C and the line segment identification data indicating the line segment between the vertex B and the vertex C of the building H20 and line segment identification data indicating a line segment between the vertex C and the vertex D of the building H20 are associated with the intersection P_{H20-C}. The unobstructed-view-range detection unit 144b generates a line segment B20a-1 connecting a coordinate of the intersection P_{H20-c} and a coordinate of the intersection P_{H20-1}.

Based on the read intersection data and the read line segment identification data of the building H20, the unobstructed-view-range detection unit 144b selects the intersection P_{H20-c} as intersection data in which an X coordinate is a maximum value among intersection data matching the line segment identification data indicating the line segment between the vertex C and the vertex D of the building H20 and selects an intersection P_{H20-2} as intersection data in which an X coordinate is a minimum value among the intersection data. The unobstructed-view-range detection unit 144b generates a line segment B20a-2 connecting the coordinate of the intersection P_{H20-c} and a coordinate of the intersection P_{H20-2}.

The unobstructed-view-range detection unit 144b detects the generated line segments B20a-1 and B20a-2 as unobstructed view ranges of the building H20. The unobstructed-view-range detection unit 144b writes data indicating the detected unobstructed view ranges of the line segments B20a-1 and B20a-2 in the data storage unit 15 in association with the building identification data of the building H20 corresponding to the unobstructed view range and causes the data storage unit 15 to store the data. The blocking-direction detection unit 143b detects, as a range of a blocking direction, minimum θ₁ and maximum θ₂ in direction data corresponding to the detected unobstructed view range and writes data indicating the detected range of the blocking direction in the data storage unit 15 and causes the data storage unit 15 to store the data (step Sb11).

The unobstructed-view-detection-line setting unit 145 sets length obtained by adding a predetermined detection length width to present r as a radius r of a new unobstructed view detection line (step Sb12). The unobstructed-view-detection-line setting unit 145 determines whether new r exceeds length of a predetermined detection line maximum length (step Sb13). As shown in FIG. 12(b), the unobstructed-view-detection-line setting unit 145 sets an unobstructed view detection line 91 having a new radius r₂. Here, r₂=r₁+detection length width and r₂ is equal to or smaller than the length of the detection line maximum length. Accordingly, the unobstructed-view-detection-line setting unit 145 determines that new r₂ does not exceed the length of the detection line maximum length (step Sb13—No).

The unobstructed-view-detection-line setting unit 145 sets “0°” as an initial value of an angle θ in the direction of the unobstructed view detection line 91 (step Sb4). Thereafter, like the processing explained with reference to FIG. 12(a), the processing in step Sb5 to step Sb10 is repeatedly performed. The intersection detection unit 146 detects an intersection with a building H21 at θ₃ to θ₄.

The intersection detection unit 146 detects an intersection with the building H20 at θ₅ to θ₆. The data storage unit 15 stores data of angles indicating minimum and maximum directions associated with the unobstructed view ranges corresponding to the line segments B20a-1 an B20a-2, that is, θ₁ and θ₂. Accordingly, as shown in FIG. 12(a), in a range of θ₅ to θ₆, a region 100 in a range of θ₁ to θ₂ is a region not having an unobstructed view from the pole 40 because of the line segments B20a-1 and B20a-2.

Therefore, when θ is included in the range of θ₁ to θ₂, in step Sb5, the unobstructed-view-detection-line setting unit 145 determines that an unobstructed view range for θ is recorded (step Sb5—Yes) and advances the processing to step Sb9. Accordingly, the intersection detection unit 146 does not perform the processing in steps Sb7 and Sb8 on the range of θ₁ to θ₂.

When the unobstructed view detection line 90 having the radius “r₂” rotates once, a track of an end point of the unobstructed view detection line 91 becomes a circle 121. At this stage, a plurality of intersection data concerning the building H21 in a range of a direction from θ₃ to θ₄ is stored in the data storage unit 15. A plurality of intersection data concerning the building H20 in a range of a direction excluding the range of θ₁ to θ₂ in a range of a direction from θ₃ to θ₆ are stored in the data storage unit 15.

In step Sb11, the unobstructed-view-range detection unit 144b reads, from the data storage unit 15, intersection data coinciding with building identification data of the building H21 and line segment identification data and direction data corresponding to the intersection data. The unobstructed-view-range detection unit 144b connects, based on the read intersection data and the read line segment identification data, coordinates indicated by the intersection data in which the line segment identification data is the same, generates a line segment B21 shown in FIG. 12(b), and detects the generated line segment B21 as an unobstructed view range of the building H21.

The unobstructed-view-range detection unit 144b writes data indicating the detected unobstructed view range of the line segment B21 in the data storage unit 15 in association with the building identification data of the building H21 corresponding to the unobstructed view range and causes the data storage unit 15 to store the data. The blocking-direction detection unit 143b detects, as a range of a blocking direction, minimum θ₃ and maximum θ₄ in direction data corresponding to the detected unobstructed view range and writes data indicating the detected range of the blocking direction in the data storage unit 15 and causes the data storage unit 15 to store the data.

In step Sb11, the unobstructed-view-range detection unit 144b reads, from the data storage unit 15, intersection data coinciding with the building identification data of the building H20 detected by the unobstructed view detection line 91 and line segment identification data and direction data corresponding to the intersection data.

The unobstructed-view-range detection unit 144b connects, based on the read intersection data and the read line segment identification data, coordinates indicated by the intersection data in which the line segment identification data is the same to generate a line segment and detects the generated line segment as an unobstructed view range of the building H20. At this time, the unobstructed-view-range detection unit 144b generates, as new line segments, a line segment B20b and a line segment B20c shown in FIG. 12(b) and detects the respective line segments B20b and B20c as unobstructed view ranges of the building H20.

The unobstructed-view-range detection unit 144b writes data indicating the detected unobstructed view ranges of the line segments B20b and B20c in the data storage unit 15 in association with the building identification data of the building H20 corresponding to the unobstructed view ranges and causes the data storage unit 15 to store the data. The blocking-direction detection unit 143b detects, as a range of a blocking direction, a minimum direction angle and a maximum direction angle in direction data corresponding to the detected unobstructed view ranges and writes data indicating the detected range of the blocking direction in the data storage unit 15 and causes the data storage unit 15 to store the data.

Note that a range of a blocking angle blocked by the unobstructed view range of the line segment B20b is a maximum angle θ₁′ at which a minimum direction angle is θ₅ and a maximum direction angle does not exceed θ₁. A range of a blocking angle blocked by the unobstructed view range of the line segment B20c is a minimum angle θ₂′ at which a minimum direction angle exceeds θ₂. An angle in a maximum direction is θ₆. θ₁′ and θ₂′ are any angles of θ set by the unobstructed-view-detection-line setting unit 145 in step Sb9.

When the radius r set anew in step Sb12 by the unobstructed-view-detection-line setting unit 145 reaches length exceeding the length of the detection maximum length, in step Sb13, the unobstructed-view-detection-line setting unit 145 determines that the radius r exceeds the length of the detection maximum length (step Sb13—Yes). The data acquisition unit 140 determines whether evaluation is performed about all base stations. That is, the data acquisition unit 140 determines whether i is equal to or larger than N (step Sb14). When determining that i is not equal to or larger than N (step Sb14—No), the data acquisition unit 140 adds 1 to i and selects the next base station candidate position data (step Sb15). The processing in step Sb3 and subsequent steps is performed. On the other hand, when determining that i is equal to or larger than N (step Sb14—Yes), the data acquisition unit 140 ends the processing.

Note that, when the processing is advanced to step Sb15, data such as an unobstructed view range of each of the buildings corresponding to the “i=1”-th base station candidate position data is stored in the data storage unit 15. Therefore, the data is copied to other storage regions as data corresponding to the “i=1”-th base station candidate position data. The data storage unit 15 is initialized.

Note that, in step Sb5, it is determined whether the intersection data with respect to the direction of θ is recorded. A ground for the determination is as explained below. In step Sb8, the intersection detection unit 146 detects an intersection at the shortest distance from the position of the utility pole 40. In step Sb12, the unobstructed-view-detection-line setting unit 145 performs processing for increasing the length of the unobstructed view detection line. Accordingly, when intersection data is already stored in the data storage unit 15 in a certain direction, the intersection is an intersection at the shortest distance from the utility pole 40 in the direction. It is unnecessary to further detect an intersection in the direction.

In the unobstructed-view-determination processing unit 14b in the second embodiment explained above, the unobstructed-view-detection-line setting unit 145 rotates, in one direction, an unobstructed view detection line starting from the position of the base station candidate position data, the line length of the unobstructed view detection line increasing stepwise. The intersection detection unit 146 detects an intersection of the unobstructed view detection line and a contour line of a building, the intersection being an intersection at the shortest distance from the position indicated by the base station candidate position data, and detects intersection data indicating a coordinate of the detected intersection, building identification data indicating a building in which the intersection is present, line segment identification data indicating to which side of the building the intersection belongs, and direction data indicating the direction of the unobstructed view detection line. The unobstructed-view-range detection unit 144b extracts intersection data in which the building identification data is the same and the line segment identification data is the same, generates a line segment connecting coordinates of the intersection data included in the extracted combination, and detects the generated line segment as an unobstructed view range of the building corresponding to the building identification data. The blocking-direction detection unit 143b detects a range of a blocking direction blocked by the unobstructed view range detected by the unobstructed-view-range detection unit 144b. When intersection data corresponding to the direction of the unobstructed view detection line is already detected or when the direction of the unobstructed view detection line is included in the blocking direction, the intersection detection unit 146 does not perform detection of an intersection.

With the configuration in the second embodiment explained above, as in the first embodiment, it is possible to narrow down, on a map, candidates of buildings in which terminal stations are installed. Therefore, it is possible to greatly reduce determination processing with the point group data information. In the processing for narrowing down, on map data, the candidates of the buildings in which the terminal stations are installed, not all of the buildings have to be evaluated one by one. That is, the buildings to be evaluated are limited to the buildings crossing the unobstructed view detection line, the length of which increases stepwise. Further, the detection is performed limitedly on a portion of the intersection crossing the unobstructed view detection line. Further, when the intersection data corresponding to the direction of the unobstructed view detection line is already detected or when the direction of the unobstructed view detection line is included in the range of the blocking direction, an intersection is not detected. Therefore, it is possible to efficiently perform the detection of the unobstructed view range.

When the configuration in the first embodiment and the configuration in the second embodiment are compared, there is a difference as explained below. In the first embodiment, for example, as shown in FIG. 8, only a part of the building H6 is included in the evaluation range 51. However, the unobstructed-view-range detection unit 144b does not detect only the unobstructed view range of the building H6 in the evaluation range 51 but detects the line segment B6 equivalent to all the unobstructed view ranges of the building H6. In contrast, in the second embodiment, there is a difference that, as shown in FIGS. 12(a) and 12(b), in the case of the unobstructed view detection line 90, the unobstructed-view-range detection unit 144b detects the line segments B20a-1 and B20a-2 equivalent to the unobstructed view range of the portion included in the circle 120, which is the track of the unobstructed view detection line 90 of the building H20. In the case of the unobstructed view detection line 91, the radius r of which is increased, the unobstructed-view-range detection unit 144b detects a line segment B20b and the line segment B20c equivalent to the remaining unobstructed view ranges of the building H20.

Note that, in step Sb11 explained above, the unobstructed-view-range detection unit 144b may determine, according to whether a coordinate of a vertex of the building is included in the range of the circle of the track of the end point of the unobstructed view detection line 90, 91, whether to set the line segment as an unobstructed view range. Note that, as explained above, the coordinate of the vertex of the building is included in the building contour data extracted by the terminal-station-candidate-position extraction unit 13-1.

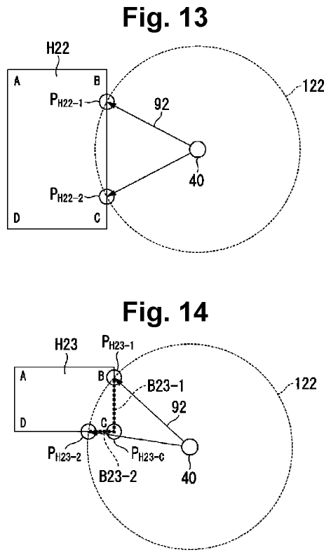

For example, a circle 122 shown in FIG. 13 is a track of an end point of an unobstructed view detection line at the time when the unobstructed view detection line 92 is rotated. In this case, the circle 122 crosses a contour line of a building H22 at intersections P_{H22-1} and P_{H22-2}. However, a coordinate of a vertex of the building H22 is not included in a range of the circle 122. In this case, the unobstructed-view-range detection unit 144b determines that an unobstructed view range is absent and does not perform detection of an unobstructed view range.

In contrast, in the case of the circle 122 shown in FIG. 14, a coordinate of a vertex C of a building H23 is included in a range of the circle 122. In this case, the unobstructed-view-range detection unit 144b detects, as unobstructed view ranges about the building H23, a line segment B23-1 connecting coordinates of an intersection P_{H23-1} and an intersection P_{H23-c} and a line segment B23-2 connecting coordinates of the intersection P_{H23-c} and an intersection P_{H23-2}.

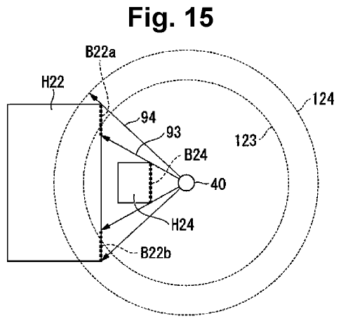

For example, when the building H22, a building H24, and the utility pole 40 are present in a positional relation shown in FIG. 15, when an unobstructed view detection line 93 is rotated, a vertex of the building H24 is included in a range of a circle 123, which is a track of an end point of the unobstructed view detection line 93, but a vertex of the building H22 is not included in the range of the circle 123. Therefore, the unobstructed-view-range detection unit 144b detects a line segment B24 as an unobstructed view range with respect to the building H24 but does not perform detection of an unobstructed view range with respect to the building H22. When an unobstructed view detection line 94 at the next stage is rotated, the vertex of the building H22 is included in a range of a circle 124, which is a track of an end point of the unobstructed view detection line 94. Therefore, at this stage, the unobstructed-view-range detection unit 144b detects a line segment B22a and a line segment B22b as unobstructed view ranges with respect to the building H22.

For example, in the case of the building H22 shown in FIG. 13, in the processing shown in FIG. 11, as a first stage, in the case of the unobstructed view detection line 92, the unobstructed-view-range detection unit 144b generates a line segment between coordinates of the intersection P_{H22-1} and the intersection P_{H22-2} as an unobstructed view detection line. As a second stage, when the length of the unobstructed view detection line 92 is increased, the unobstructed-view-range detection unit 144b generates a line segment between coordinates of the vertex B and the intersection P_{H22-1} and a line segment between coordinates of the vertex C and the intersection P_{H22-2}. That is, the unobstructed-view-range detection unit 144b performs, twice, generation of line segments to be unobstructed view ranges.

In contrast, when performing detection of an unobstructed view range when a vertex is present in a range of a circle, which is a track of an end point of the unobstructed view detection line, in the case of the unobstructed view detection line 92, the unobstructed-view-range detection unit 144b does not perform generation of a line segment to be an unobstructed view range and, when the length of the unobstructed view detection line 92 is increased, generates a line segment connecting coordinates of the vertex B and the vertex C to be an unobstructed view range. Therefore, it is possible to perform, only once, the processing for generating a line segment to be an unobstructed view range.

About the configuration in the second embodiment, in step Sb9, the unobstructed-view-detection-line setting unit 145 increases the angle in the direction of the unobstructed view detection line at the fixed detection angle width. However, the configuration of the present invention is not limited to the embodiment. For example, by setting the detection angle width large while the radius r of the unobstructed view detection line is short and setting the detection angle width small when the radius r of the unobstructed view detection line increases, it is possible to more efficiently perform the detection of an unobstructed view range.

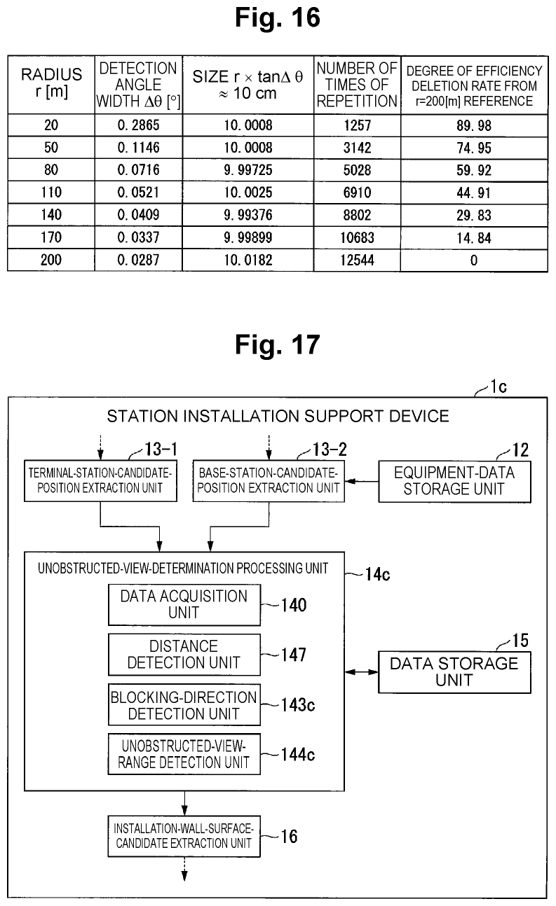

FIG. 16 is a diagram showing a table showing an example of combinations of radiuses and detection angle widths. Items in fields in the table are “radius”, “detection angle width”, “size”, “number of times of repetition”, and “degree of efficiency”. In the respective items of “radius” and “detection angle width”, length of a radius of an unobstructed view detection line and a value of a detection angle width Δθ set by the unobstructed-view-detection-line setting unit 145 are written. Units of “radius” and “detection angle width” are respectively [m] and [° ].

In the item of “size”, a value obtained by calculating r×tan (the detection angle width Δθ) is written. It is seen that the radius r and the detection angle width Δθ is decided such that the value of r×tan (the detection angle width Δθ) is approximately 10 cm.

In the item of “number of times of repetition”, a number of the number of times of repetition for rotating the unobstructed view detection line once is written. In the item of “degree of efficiency”, a value indicating a reduction rate of a reduction of the number of times of repetition based on the radius r=200[m] is written. As shown in the item of “rate of efficiency” in FIG. 16, the number of times of repetition can be more greatly reduced when an unobstructed view range is detected at a larger angle “0.286°” in the case of a narrow range, for example, r=20[m] than when all ranges are set as targets at a detection angle width “0.0287°” in the case of the largest range, for example, r=200[m]. Since a size of a detection target can be set to substantially the same length (in the example of the table in FIG. 16, approximately 10 [cm]) even if the angle is increased in this way. Therefore, it is possible to perform detection of an unobstructed view range without deteriorating accuracy.

### Third Embodiment

FIG. 17 is a block diagram showing the configuration of a station installation support device 1c according to a third embodiment. In the third embodiment, the same components as the components in the basic embodiment and the first and second embodiments are denoted by the same reference numerals and signs. Different components are explained below. The station installation support device 1c has a configuration in which the unobstructed-view-determination processing unit 14 is replaced with an unobstructed-view-determination processing unit 14c in the station installation support device 1 in the basic embodiment.

The unobstructed-view-determination processing unit 14c includes the data acquisition unit 140, a distance detection unit 147, a blocking-direction detection unit 143c, and an unobstructed-view-range detection unit 144c. The distance detection unit 147 detects, for each of buildings, a distance from a position indicated by base station candidate position data. The blocking-direction detection unit 143c detects a range of a blocking direction blocked by an unobstructed view range detected by the unobstructed-view-range detection unit 144c.

The unobstructed-view-range detection unit 144c detects buildings having unobstructed views in order from the building at the shortest distance from the position indicated by the base station candidate position data and detects, for example, with the method described in Patent Literature 1, a range of a contour line having an unobstructed view of the building having the unobstructed view as an unobstructed view range of the building. When an entire building as an unobstructed view determination target is included in the range of the blocking direction, the unobstructed-view-range detection unit 144c excludes the building from detection targets.

### (Processing by the Station Installation Support Device in the Third Embodiment)

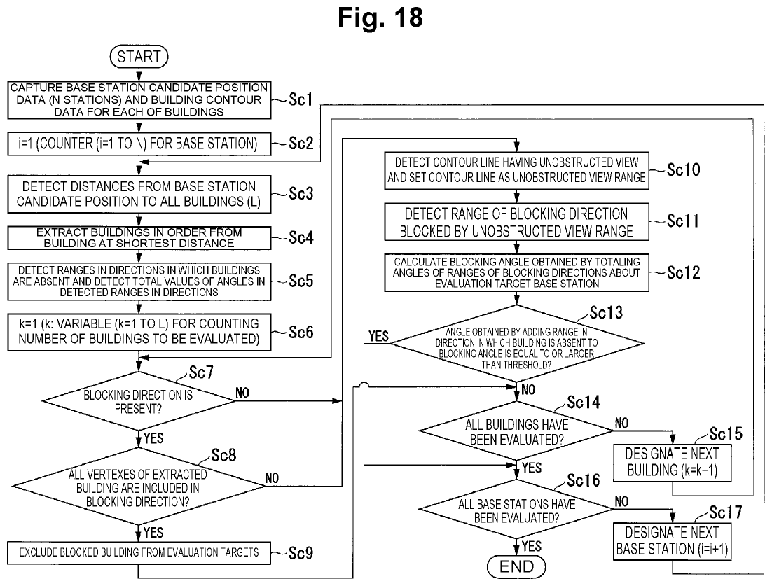

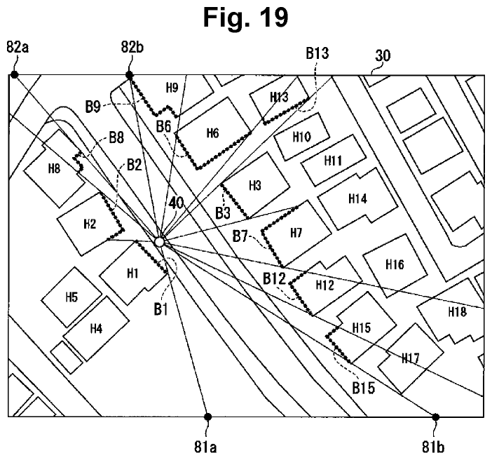

Subsequently, processing by the station installation support device 1c in the third embodiment is explained with reference to FIG. 18 and FIG. 19. FIG. 18 is a flowchart showing a flow of processing of a station installation support method by the station installation support device 1c.

About step Sc1 and step Sc2, the same processing as the processing in step Sa1 and step Sa2 in the first embodiment is performed by the data acquisition unit 140.

In a range of a design area designated by the design-area designation unit 11, about all buildings included in the range of the design area, the distance detection unit 147 detects, based on building contour data of the buildings, distances from a position indicated by the “i=1”-th base station candidate position data” to the buildings (step Sc3).

Note that positions serving as references in measuring distances in the buildings are, for example, coordinates of vertexes included in building contour data of one building. The distance detection unit 147 detects, for example, with respect to one building, for each of vertexes, distances to a position indicated by the base station candidate position data and detects the shortest distance among the detected distances as a distance to the building from the position indicated by the base station candidate position data.

The unobstructed-view-range detection unit 144c extracts, based on the distances for each of the buildings detected by the distance detection unit 147, the buildings in order from the building closest from the position indicated by the base station candidate position data (step Sc4).

For example, it is assumed that map data of a design area segmented from the map data designated by the design-area designation unit 11 is the map data 30 shown in FIG. 19. In the map data 30, a position indicated by the “i=1”-th base station candidate position data is the utility pole 40. At this time, the distances detected by the distance detection unit 147 are shorter in ascending order of numerical values included in the signs of the buildings H1, H2, H3. In this case, the unobstructed-view-range detection unit 144c extracts the buildings H1, H2, H3, in this order.

The unobstructed-view-range detection unit 144c sets an unobstructed view detection line having length to reach the ends of the map data 30 in all the directions around the position of the utility pole 40 and detects ranges in directions in which buildings are absent (step Sc5). In the case of FIG. 19, there are two ranges in directions in which buildings are absent. One range is a range from a direction indicated by a line segment from the position of the utility pole 40 to a point indicated by a sign 81a to a direction indicated by a line segment from the position of the utility pole 40 to a point indicated by a sign 81b. The other range is a range from a direction indicated by a line segment from the position of the utility pole 40 to a point indicated by a sign 82a to a direction indicated by a line segment from the position of the utility pole 40 to a point indicated by a sign 82b.

The unobstructed-view-range detection unit 144c calculates a total value of angles of the detected ranges in the directions in which buildings are absent. That is, the unobstructed-view-range detection unit 144c calculates a total value obtained by adding up an angle formed by the line segment from the position of the utility pole 40 to the point indicated by the sign 81a and the line segment from the position of the utility pole 40 to the point indicated by the sign 81b and an angle formed by the line segment from the position of the utility pole 40 to the point indicated by the sign 82a and the line segment from the position of the utility pole 40 to the point indicated by the sign 82b. The unobstructed-view-range detection unit 144c writes data of the calculated total value of the angles of the ranges in the directions in which buildings are absent in the data storage unit 15 and causes the data storage unit 15 to store the data.

In order to perform evaluation of unobstructed views of the buildings in the order of the extraction, the unobstructed-view-range detection unit 144c sets a counter “k” as a variable for counting buildings and substitutes “1” in “k” as an initial value. The unobstructed-view-range detection unit 144c selects, as a k=1-th building, the building H1 at the shortest distance from the position of the utility pole 40 extracted first in step Sc4 (step Sc6).

About steps Sc7, Sc8, and Sc9, the same processing as the processing in steps Sa6, Sa7, and Sa8 in the first embodiment is respectively performed by the unobstructed-view-range detection unit 144c. When determining No in step Sc7 and step Sc8, the unobstructed-view-range detection unit 144c advances the processing to step Sc10.

The unobstructed-view-range detection unit 144c detects, based on building contour data of the “k=1”-th building H1 and the position of the utility pole 40, using the method described in Patent Literature 1, the line segment B1, which is a portion of a contour line having an unobstructed view, and detects the line segment B1 as the unobstructed view range of the building H1. The unobstructed-view-range detection unit 144c writes data indicating the detected unobstructed view range of the building H1 in the data storage unit 15 in association with building identification data of the building H1 and causes the data storage unit 15 to store the data (step Sc10).

The blocking-direction detection unit 143c detects, based on the line segment B1 detected by the unobstructed-view-range detection unit 144c, ranges of blocking directions blocked by the building H1 having an unobstructed view. The blocking-direction detection unit 143c writes data indicating the detected ranges for the blocking directions in the data storage unit 15 and causes the data storage unit 15 to store the data (step Sc11). The blocking-direction detection unit 143c refers to the data storage unit 15 and calculates a blocking angle obtained by totaling angles of the ranges of the blocking directions (step Sc12).

The unobstructed-view-range detection unit 144c reads, from the data storage unit 15, the data of the total value of the angles of the ranges in the directions in which buildings are absent. The unobstructed-view-range detection unit 144c calculates an added-up value obtained by adding up the read total value of the angles of the ranges in the directions in which buildings are absent and the calculated blocking angle. The unobstructed-view-range detection unit 144c determines whether the calculated added-up value is equal to or larger than a threshold (step Sc13). As the threshold, for example, a value of approximately “355°” is applied.

When determining that the calculated added-up value is not equal to or larger than the threshold (step Sc13—No), the unobstructed-view-range detection unit 144c determines that the evaluation of the unobstructed views of the buildings is insufficient and subsequently determines whether all the buildings have been evaluated (step Sc14). That is, the unobstructed-view-range detection unit 144c determines whether k is equal to or larger than L. When determining that k is not equal to or larger than L (step Sc14—No), the unobstructed-view-range detection unit 144c adds 1 to k and selects the building H2 at the second shortest distance from the utility pole 40 (step Sc15). On the other hand, when determining that k is equal to or larger than L (step Sc14—Yes), the unobstructed-view-range detection unit 144c advances the processing to step Sc16 in order to perform evaluation of an unobstructed view about the next base station candidate position.

When determining in step Sc13 that the calculated added-up value is equal to or larger than the threshold (step Sc13—Yes), the unobstructed-view-range detection unit 144c determines that unobstructed views of buildings have been evaluated about sufficient ranges of angles in the map data 30. In order to perform evaluation of unobstructed views about the next base station candidate position, the unobstructed-view-range detection unit 144c advances the processing to step Sc16.

The data acquisition unit 140 determines whether evaluation is performed about all base stations. That is, the data acquisition unit 140 determines whether i is equal to or larger than N (step Sc16). When determining that i is not equal to or larger than N (step Sc16—No), the data acquisition unit 140 adds 1 to i and selects the next base station candidate position data (step Sc17). Processing in step Sc3 and subsequent steps is performed. On the other hand, when determining that i is equal to or larger than N (step Sc16—Yes), the data acquisition unit 140 ends the processing.

Note that, when the processing is advanced to step Sc17, data such as unobstructed view ranges for each of the buildings corresponding to the “i=1”-th base station candidate position data is stored in the data storage unit 15. Therefore, the data is copied to other storage regions as data corresponding to the “i=1”-th base station candidate position data. The data storage unit 15 is initialized.

Consequently, as shown in FIG. 19, the unobstructed-view-range detection unit 144c detects, in the order of the buildings H1, H2, H3, H6, H7, H8, H9, H12, H13, and H15, these buildings as buildings having unobstructed views. In the buildings H1, H2, H3, H6, H7, H8, H9, H12, H13, and H15 having the unobstructed views, the unobstructed-view-range detection unit 144c detects the line segments B1, B2, B3, B6, B7, B8, B9, B12, B13, and B15 as unobstructed view ranges. In the processing in step Sc9, the unobstructed-view-range detection unit 144c excludes, from evaluation targets, the buildings H4, H5, H10, H11, H14, H16, H17, H18, and the like present in ranges in blocking directions blocked by unobstructed view ranges of buildings having unobstructed views.

In the unobstructed-view-determination processing unit 14c in the third embodiment explained above, the distance detection unit 147 detects, for each of the buildings, distances from the position of the base station candidate position data. The unobstructed-view-range detection unit 144c detects buildings having unobstructed views in order from the building at the shortest distance from the position of the base station candidate position data, detects a range of a contour line having an unobstructed view of the building having the unobstructed view, and detects the detected contour line as an unobstructed view range of the building. The blocking-direction detection unit 143c detects a range of a blocking direction blocked by the unobstructed view range detected by the unobstructed-view-range detection unit 144c. When an entire building as an unobstructed view determination target is included in the range of the blocking direction, the unobstructed-view-range detection unit 144c excludes the building from detection targets of a contour line having an unobstructed view.

With the configuration in the third embodiment explained above, as in the first and second embodiments, it is possible to narrow down, on a map, candidates of buildings in which terminal stations are installed. Therefore, it is possible to greatly reduce determination processing with point group data information. In processing for narrowing down, on map data, the candidates of the buildings in which the terminal stations are installed, unobstructed views are evaluated in order from the building closest to the base station candidate position. The buildings present in the range of the blocking direction in which unobstructed views from the base stations are blocked by the unobstructed view ranges of the buildings having the unobstructed views are excluded from the evaluation targets. Accordingly, not all of the buildings have to be evaluated one by one. It is possible to efficiently perform the evaluation of unobstructed views.

Note that, in step Sc13 in the third embodiment, “355°” is applied as the threshold. A ground for the application of “355°” is as explained below. For example, it is assumed that a communicable distance of wireless communication is 100 m in millimeter wave radio used as a target. At this time, length in which detection of an unobstructed view range is necessary on a wall of a building present in a boundary of a communicable range needs to be set to a value exceeding an antenna size of a radio device set on a wall surface of the building as a terminal station. For example, a size of approximately 8.7 cm is assumed as an antenna size and a size of approximately 10 cm is assumed as a size of the radio device in that case. In order to satisfy approximately 10 cm, a range of an angle for detecting an unobstructed view range that is centered on the utility pole 40 needs to be equal to or smaller than 10 cm÷3.14÷100 m×360°=0.1°. In the third embodiment, when angles of ranges in a plurality of directions in which buildings are absent are further added to a blocking angle obtained by adding up angles blocked by a plurality of buildings, when the number of angles to be added is estimated as, for example, fifty, the numbers of gaps among the angles is also fifty. When the remaining angle is 5°, a range of an average angle of one gap is 5°÷50=0.1°, which satisfies 0.1° or less described above. Therefore, in step Sc13, “355°” obtained by subtracting 5° from 360° is adopted as the threshold.

In the third embodiment explained above, the distance detection unit 147 measures the distance between the position of the utility pole 40 and the position of the vertex of the building. However, the configuration of the present invention is not limited to the embodiment. For example, the distance detection unit 147 may draw a contour line of the building based on the building contour data, detect a point on the contour line closest from the position of the utility pole 40, and detect the distance between the detected point and the position of the utility pole 40.

### Fourth Embodiment

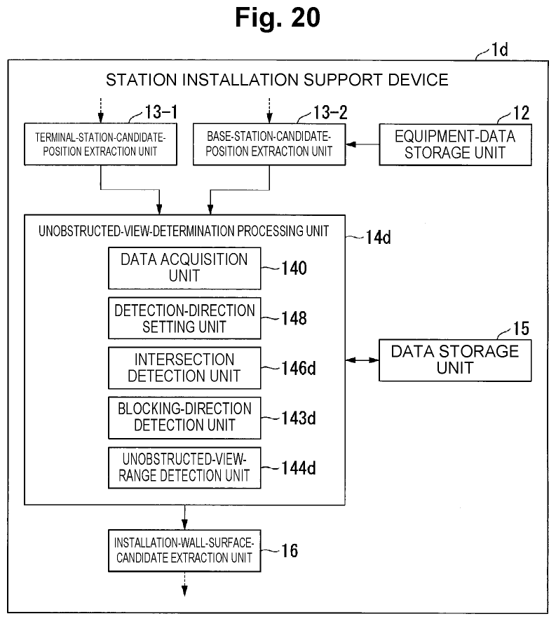

FIG. 20 is a block diagram showing the configuration of a station installation support device 1d according to a fourth embodiment. In the fourth embodiment, the same components as the components in the first to third embodiments are denoted by the same reference numerals and signs. Different components are explained below. The station installation support device 1d has a configuration in which the unobstructed-view-determination processing unit 14 is replaced with an unobstructed-view-determination processing unit 14d in the station installation support device 1 in the basic embodiment.

The unobstructed-view-determination processing unit 14d includes the data acquisition unit 140, a detection-direction setting unit 148, an intersection detection unit 146d, a blocking-direction detection unit 143d, and an unobstructed-view-range detection unit 144d.

The detection-direction setting unit 148 sets, as a designated detection direction, one direction determined in advance around a position indicated by base station candidate position data. The detection-direction setting unit 148 sets, as an auxiliary detection direction, an angle rotated at a rotation angle interval with respect to the designated detection direction. The detection-direction setting unit 148 sets an initial value of the rotation angle interval to 360° and, when the angle in the auxiliary detection direction is 360° or more, sets a half angle of the rotation angle interval as a new rotation angle interval.

The intersection detection unit 146d detects an intersection with a contour line of a building that a straight line extended in the designated detection direction or the auxiliary detection direction starting from the position indicated by the base station candidate position data crosses first. The intersection detection unit 146d detects intersection data indicating a coordinate of the detected intersection, building identification data indicating a building in which the intersection is present, and line segment identification data indicating in which contour line of the building the intersection is present. When the designated detection direction or the auxiliary detection direction is included in a range of a blocking direction, the intersection detection unit 146d does not perform detection of an intersection.

When two or more intersections detected by the intersection detection unit 146d are present in the same building, the blocking-direction detection unit 143d detects the range of the blocking direction based on the designated detection direction or the auxiliary detection direction at the time when each of the intersections is detected.

The unobstructed-view-range detection unit 144d extracts a combination of intersection data in which the building identification data is the same and the line segment identification data is the same. The unobstructed-view-range detection unit 144d generates a line segment connecting coordinates of the intersection data included in the extracted combination. The unobstructed-view-range detection unit 144d detects the generated line segment as an unobstructed view range of a building corresponding to the building identification data.

### (Processing by the Station Installation Support Device in the Fourth Embodiment)

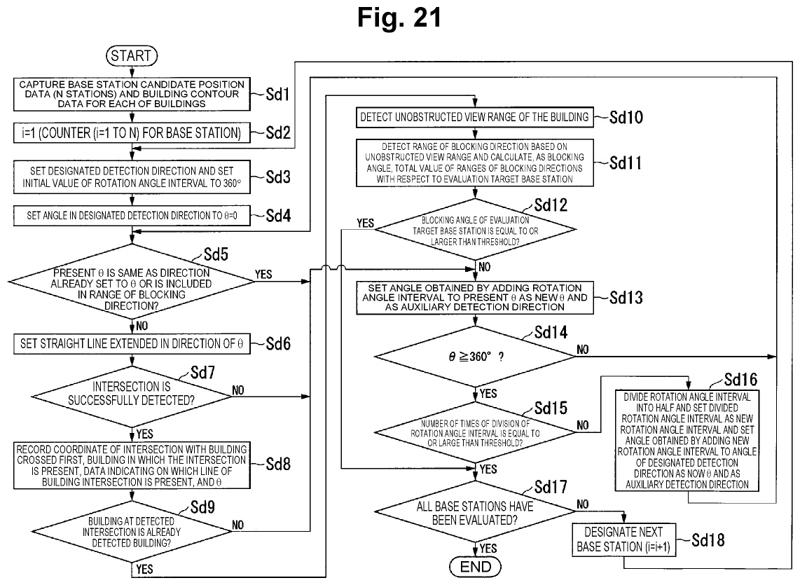

Subsequently, processing by the station installation support device 1d in the second embodiment is explained with reference to FIG. 21 to FIG. 23. FIG. 21 is a flowchart showing a flow of processing of a station installation support method by the station installation support device 1d.

About step Sd1 and step Sd2, the same processing as the processing in step Sa1 and step Sa2 in the first embodiment is performed by the data acquisition unit 140.

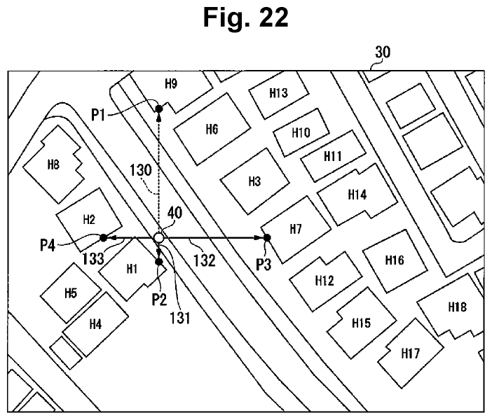

In map data 30 shown in FIG. 22, an upward direction is a “north” direction, a downward direction is a “south” direction, a right direction is an “east” direction, and a left direction is a “west” direction. It is assumed that an angle increases in the order of north, east, south, and west, that is, clockwise. The detection-direction setting unit 148 sets, for example, the designated detection direction as the north direction and sets, for example, “360°” as an initial value of the rotation angle interval (step Sd3).

### (Detection of an Intersection in the North Direction)

The detection-direction setting unit 148 sets an angle θ in the designated detection direction to “0°” (step Sd4). The intersection detection unit 146d refers to the data storage unit 15 and determines whether a direction of present θ is the same as a direction already set to θ or is included in the range of the blocking direction (step Sd5). In the data storage unit 15, neither already set θ nor data indicating the range of the blocking direction is recorded. Accordingly, the intersection detection unit 146d determines that the direction of present θ is not the same as the direction already set to θ and is not included in the range of the blocking direction (step Sd5—No).

The intersection detection unit 146d extends a straight line in the direction of θ starting from the position indicated by the base station candidate position data, that is, the position of the utility pole 40 and sets the extended straight line as an unobstructed view detection line (step Sd6). The intersection detection unit 146d determines whether an intersection is successfully detected between the unobstructed view detection line and the building (step Sd7). When determining that an intersection is not successfully detected (step Sd7—No), the intersection detection unit 146 advances the processing to step Sd13.

On the other hand, when determining that an intersection is successfully detected (step Sd7—Yes), the intersection detection unit 146d detects intersection data indicating a coordinate of an intersection where the unobstructed view detection line crosses the building first, building identification data of a building in which the intersection is present, and line segment identification data indicating a side of the building on which the intersection is present. The intersection detection unit 146d writes the detected intersection data, the detected building identification data, the detected line segment identification data, and θ in the data storage unit 15 and causes the data storage unit 15 to store the data and θ (step Sd8).

For example, as shown in FIG. 22, when θ is “0°”, instep Sd6, the intersection detection unit 146d extends a straight line to θ starting from the position of the utility pole 40 and sets the extended straight line as an unobstructed view detection line 130.

The intersection detection unit 146d detects an intersection P1 of the unobstructed view detection line 130 and the building H9. The intersection detection unit 146d determines Yes in step Sd7 and, in step Sd8, detects intersection data of the intersection P1, building identification data of the building H9, and line segment identification data indicating a side on which the intersection P1 is present in the building H9. The intersection detection unit 146d writes the detected intersection data of the intersection P1, the detected building identification data, the detected line segment identification data, and θ “0°” in the data storage unit 15 and causes the data storage unit 15 to store the data and θ “0°”.

The unobstructed-view-range detection unit 144d refers to the data storage unit 15 and determines whether a building at the intersection detected by the intersection detection unit 146d is an already detected building (step Sd9). In the case of the designated detection direction, an already detected building is absent. Accordingly, the unobstructed-view-range detection unit 144d determines that the building at the detected intersection is not an already detected building (step Sd9—No) and advances the processing to step Sd13.

The detection-direction setting unit 148 sets, as new θ, an angle added with a rotation angle interval and sets a direction of new θ as an auxiliary detection direction (step Sd13). Since the rotation angle interval is “360°”, new θ is “0+360°=360°”. The detection-direction setting unit 148 determines whether new θ is 360° or more (step Sd14). Since new θ is 360°, the detection-direction setting unit 148 determines that new θ is 360° or more (step Sd14—Yes).

The detection-direction setting unit 148 determines whether the number of times of division of the rotation angle interval is equal to or larger than a predetermined threshold (step Sd15). For example, it is assumed that the predetermined threshold is “19”. The detection-direction setting unit 148 does not divide the rotation angle interval at all.

Accordingly, the detection-direction setting unit 148 determines that the number of times of division of the rotation angle interval is not equal to or larger than the predetermined threshold (step Sd15—No).

The detection-direction setting unit 148 divides the present rotation angle interval into half and sets “360°÷2=180°” as a new rotation angle interval. The detection-direction setting unit 148 sets, as new θ, an angle “180°” obtained by adding the new rotation angle interval “180°” to the angle “0°” in the designated detection direction and sets a direction of new θ as an auxiliary detection direction (step Sd16) and advances the processing to step Sd5.

### (Detection of an Intersection in the South Direction)

The intersection detection unit 146d determines that the direction of present θ “180°” is not the same as a direction already set to θ and is not included in the range of the blocking direction (step Sd5—No).

As shown in FIG. 22, when θ is “180°”, in step Sd6, the intersection detection unit 146d extends a straight line to θ “180°”, that is, in the south direction starting from the position of the utility pole 40 and sets the extended straight line as an unobstructed view detection line 131.

The intersection detection unit 146d detects an intersection P2 of the unobstructed view detection line 131 and the building H1. The intersection detection unit 146d determines Yes in step Sd7 and, in step Sd8, detects intersection data of the intersection P2, building identification data of the building H1, and line segment identification data indicating a side on which the intersection P2 is present in the building H1. The intersection detection unit 146d writes the detected intersection data of the intersection P2, the detected building identification data, the detected line segment identification data, and θ “180°” in the data storage unit 15 and causes the data storage unit 15 to store the data and θ “180°”.

The unobstructed-view-range detection unit 144d refers to the data storage unit 15 and determines that the building H1 at the detected intersection is not the already detected building H9 (step Sd9—No) and advances the processing to step Sd13.

The detection-direction setting unit 148 sets, as new θ, an angle added with a rotation angle interval and sets a direction of new θ as an auxiliary detection direction (step Sd13). Since the rotation angle interval is “180°”, new θ is “180°+180°=360°”. The detection-direction setting unit 148 determines that new θ is 360° or more (step Sd14—Yes). The detection-direction setting unit 148 determines that the number of times of division of the rotation angle interval is “1” and is not equal to or larger than the predetermined threshold (step Sd15—No).

The detection-direction setting unit 148 divides the present rotation angle interval into half and sets “180°÷2=90°” as a new rotation angle interval. The detection-direction setting unit 148 sets, as new θ, an angle “90°” obtained by adding the new rotation angle interval “90°” to the angle “0°” in the designated detection direction and sets a direction of new θ as an auxiliary detection direction (step Sd16) and advances the processing to step Sd5.

### (Detection of an Intersection in the East Direction)

The intersection detection unit 146d determines that the direction of present θ “90°” is not the same as a direction already set to θ and is not included in the range of the blocking direction (step Sd5—No).

As shown in FIG. 22, when θ is “90°”, in step d6, the intersection detection unit 146d extends a straight line to θ “90°”, that is, in the east direction starting from the position of the utility pole 40 and sets the extended straight line as an unobstructed view detection line 132.

The intersection detection unit 146d detects an intersection P3 of the unobstructed view detection line 132 and the building H7. The intersection detection unit 146d determines Yes in step Sd7 and, in step Sd8, detects intersection data of the intersection P3, building identification data of the building H7, and line segment identification data indicating a side on which the intersection P3 is present in the building H7. The intersection detection unit 146d writes the detected intersection data of the intersection P3, the detected building identification data, the detected line segment identification data, and θ “90°” in the data storage unit 15 and causes the data storage unit 15 to store the data and θ “90°”.

The unobstructed-view-range detection unit 144d refers to the data storage unit 15 and determines that the building H7 at the detected intersection is not the already detected buildings H9 and H1 (step Sd9—No) and advances the processing to step Sd13.

The detection-direction setting unit 148 sets, as new θ, a direction “180°” obtained by adding the rotation angle interval “90°” to θ “90°” and sets a direction of new θ as an auxiliary detection direction (step Sd13). The detection-direction setting unit 148 determines that new θ “180°” is not 360° or more (step Sd14—No).

The intersection detection unit 146d refers to the data storage unit 15 and determines that a direction of present θ “180°” is the same as the direction of θ “180°” at the time when the unobstructed view detection line 131 is set (step Sd5—Yes) and advances the processing to step Sd13.

The detection-direction setting unit 148 sets, as new θ″, a direction “270°” obtained by adding the rotation angle interval “90°” to θ “180°” and sets a direction of new θ as an auxiliary detection direction (step Sd13). The detection-direction setting unit 148 determines that new θ “270°” is not 360° or more (step Sd14—No).

### (Detection of an Intersection in the West Direction)

The intersection detection unit 146d determines that the direction of present θ “270°” is not the same as a direction already set to θ and is not included in the range of the blocking direction (step Sd5—No).

As shown in FIG. 22, when θ is “270°”, in step Sd6, the intersection detection unit 146d extends a straight line to θ “270°”, that is, in the west direction starting from the position of the utility pole 40 and sets the extended straight line as an unobstructed view detection line 133.

The intersection detection unit 146d detects an intersection P4 of the unobstructed view detection line 133 and the building H2. The intersection detection unit 146d determines Yes in step Sd7 and, in step Sd8, detects intersection data of the intersection P4, building identification data of the building H2, and line segment identification data indicating a side on which the intersection P4 is present in the building H2. The intersection detection unit 146d writes the detected intersection data of the intersection P4, the detected building identification data, the detected line segment identification data, and θ “270°” in the data storage unit 15 and causes the data storage unit 15 to store the data and θ “270°”.

The unobstructed-view-range detection unit 144d refers to the data storage unit 15 and determines that the building H2 at the detected intersection is not the already detected buildings H9, H1, and H7 (step Sd9—No) and advances the processing to step Sd13.

The detection-direction setting unit 148 sets, as new θ, a direction added with a rotation angle interval and sets a direction of new θ as an auxiliary detection direction (step Sd13). Since the rotation angle interval is “90°”, new θ is “270°+90°=360°”. The detection-direction setting unit 148 determines that new θ is 360° or more (step Sd14—Yes).

The detection-direction setting unit 148 determines that the number of times of division of the rotation angle interval is “2” and is not equal to or larger than the predetermined threshold (step Sd15—No).

Until the rotation angle interval is divided for the second time, the intersection detection unit 146d performs detection of intersections in the order of the intersection P1 in the north direction, the intersection P2 in the south direction, the intersection P3 in the east direction, and the intersection P4 in the west direction. Division of the rotation angle interval in performed three or more times is explained below.

### (When the Number of Times of Division is Three)

The detection-direction setting unit 148 divides the rotation angle interval for the third time. That is, the detection-direction setting unit 148 further divides the present rotation angle interval into half and sets “90°÷2=45°” as a new rotation angle interval. The detection-direction setting unit 148 sets, as new θ, a direction “45°” obtained by adding the new rotation angle interval “45°” to the angle “0°” in the designated detection direction, sets a direction of new θ as an auxiliary detection direction (step Sd16), and advances the processing to step Sd5.

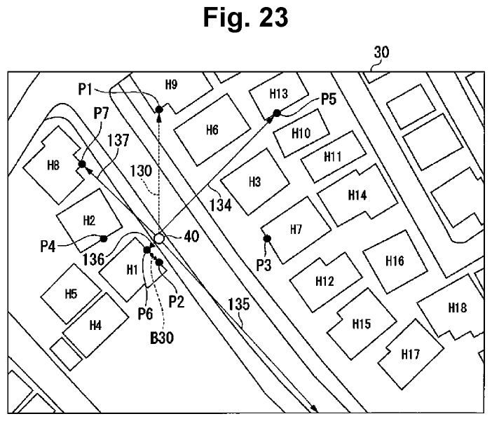

FIG. 23 is a diagram showing processing performed when the rotation angle interval is set to “45°”. When the rotation angle interval is set to “45°”, the angle θ in the auxiliary detection direction changes in the order of “45°”, “90°”, “135°”, “180°”, “225°”, “270°”, “315°”, and “360°”. Among these angles, about “90°”, “180°”, and “270°”, in step Sd5, directions of these angles are the same as the directions already set as θ. Accordingly, the intersection detection unit 146d determines Yes in step Sd5 and does not perform the processing in steps Sd6, Sd7, and Sd8. When the angle θ in the auxiliary detection direction is “360°”, the detection-direction setting unit 148 determines Yes in step Sd14 and advances the processing to step Sd15.

When the angle θ in the auxiliary detection direction is directions of “45°” and “315°” among “45°”, “135°”, “225°”, and “315°”, that is, northeast and northwest directions, the same processing as the processing in the north, south, east, and west directions explained above is performed.

### (In the Case of “45°” and “315°”)

When θ is “45°”, the intersection detection unit 146d sets an unobstructed view detection line 134 and detects an intersection P5 in step Sd6 and determines Yes in step Sd7. In step Sd8, the intersection detection unit 146d detects intersection data of the intersection P5, building identification data of the building H13, and line segment identification data indicating a side on which the intersection P5 is present in the building H13. The intersection detection unit 146d writes the detected intersection data of the intersection P5, the detected building identification data, the line segment identification data, and θ “45°” in the data storage unit 15 and causes the data storage unit 15 to store the data and θ “45°”.

When θ is “315°”, the intersection detection unit 146d sets an unobstructed view detection line 137 and detects an intersection P7 in step Sd6 and determines Yes in step Sd7. In step Sd8, the intersection detection unit 146d detects intersection data of the intersection P7, building identification data of the building H8, and line segment identification data indicating a side on which the intersection P7 is present in the building H8. The intersection detection unit 146d writes the detected intersection data of the intersection P7, the detected building identification data, the detected line segment identification data, and θ “315°” in the data storage unit 15 and causes the data storage unit 15 to store the data and θ “315°”.

### (In the Case of “135°”)

When θ is “135°”, the intersection detection unit 146d determines that the direction of present θ is not the same as the direction already set to θ and is not included in the range of the blocking direction (step Sd5—No).

As shown in FIG. 22, when θ is “135°”, in step Sd6, the intersection detection unit 146d extends a straight line to θ “135°”, that is, in the southeast direction starting from the position of the utility pole 40 and sets the extended straight line as an unobstructed view detection line 135. In this case, a building is absent on the unobstructed view detection line 135. Accordingly, the intersection detection unit 146d cannot detect an intersection. Therefore, the intersection detection unit 146d determines that an intersection cannot be detected (step Sd7—No) and advances the processing to step Sd13.

### (In the Case of “225°”)

When θ is “225°”, the intersection detection unit 146d determines that the direction of present θ is not the same as the direction already set to θ and is not included in the range of the blocking direction (step Sd5—No).

As shown in FIG. 22, when θ is “225°”, in step Sd6, the intersection detection unit 146d extends a straight line to θ “225°”, that is, in the southwest direction starting from the position of the utility pole 40 and sets the extended straight line as an unobstructed view detection line 136.

The intersection detection unit 146d detects an intersection P6 of the unobstructed view detection line 136 and the building H1. The intersection detection unit 146d determines Yes in step Sd7 and, in step Sd8, detects intersection data of the intersection P6, building identification data of the building H1, and line segment identification data indicating a side on which the intersection P6 is present in the building H1. The intersection detection unit 146d writes the detected intersection data of the intersection P6, the detected building identification data, the detected line segment identification data, and θ “225°” in the data storage unit 15 and causes the data storage unit 15 to store the data and θ “225°”.

About the building H1, the intersection P2 is detected by the unobstructed view detection line 131 at θ “180°”. Therefore, in step Sd9, the unobstructed-view-range detection unit 144d refers to the data storage unit 15 and determines that the building H1 corresponding to the intersection P6 detected by the intersection detection unit 146d is an already detected building (step Sd9—Yes).

The unobstructed-view-range detection unit 144d reads, from the data storage unit 15, the intersection data of the intersection P2 in which the building identification data is the building H1, the line segment identification data, and θ “180°”. The intersection P6 detected by the intersection detection unit 146d and the line segment identification data of the intersection P2 is the same. Accordingly, the unobstructed-view-range detection unit 144d generates, with the method of “generating a line segment to be an unobstructed view range” explained in the second embodiment, a line segment B30 connecting the intersection P6 and the intersection P2 as shown in FIG. 23. The unobstructed-view-range detection unit 144d detects the generated line segment B30 as the unobstructed view range of the building H1. The unobstructed-view-range detection unit 144d writes data indicating the detected unobstructed view range of the building H1 in the data storage unit 15 in association with the building identification data of the building H1 and causes the data storage unit 15 to store the data (step Sd10).

The blocking-direction detection unit 143d detects, as a range of a blocking direction, a range of θ “180°” of the intersection P2 to θ “225°” of the intersection P6 at both ends of the unobstructed view range detected by the unobstructed-view-range detection unit 144d. The blocking-direction detection unit 143d writes data indicating the detected range of the blocking direction in the data storage unit 15 and causes the data storage unit 15 to store the data.

The blocking-direction detection unit 143d reads data indicating all the ranges of the blocking directions from the data storage unit 15. The blocking-direction detection unit 143d totals angles indicated by the read data indicating all the ranges of the blocking directions and calculates a totaled angle as a blocking angle (step Sd1l). The data storage unit 15 stores only a combination of θ “180°” of the intersection P2 and θ “225°” of the intersection P6 as the data indicating the ranges of the blocking directions. Therefore, the blocking-direction detection unit 143d calculates “225°-180°=45°” as the blocking angle.

The blocking-direction detection unit 143d determines whether the calculated blocking angle is equal to or larger than a predetermined threshold (step Sd12). When determining that the calculated blocking angle is not equal to or larger than the predetermined threshold (step Sd12—No), the blocking-direction detection unit 143d advances the processing to step Sd13. When determining that the calculated blocking angle is equal to or larger than the predetermined threshold (step Sd12—Yes), the blocking-direction detection unit 143d advances the processing to step Sd17.

When it is assumed that, for example, 355° is decided as the threshold in step Sd12, since the calculated blocking angle “45°” is not “355°” or more, the blocking-direction detection unit 143d determines No and advances the processing to step Sd13.

### (When the Number of Times of Division is Four)

When the rotation angle interval is divided for the fourth time, the rotation angle interval calculated by the detection-direction setting unit 148 in step Sd16 is “45°÷2=22.5°”. When the rotation angle interval is 22.5°, there are fifteen auxiliary detection directions. Processing in step Sd5 performed when the auxiliary detection direction at θ “202.5°” among the auxiliary detection directions is explained.

The intersection detection unit 146d refers to the data storage unit 15 and determines whether a direction of present θ “202.5°” is the same as a direction already set to θ or is included in a range of a blocking direction (step Sd5). The data storage unit 15 stores, as the range of the blocking direction, a range of θ “180°” of the intersection P2 to θ “225°” of the intersection P6. “202.5°” is included in this range. Therefore, the intersection detection unit 146d determines that the direction of present θ “202.5°” is included in the range of the blocking direction (step Sd5—Yes) and advances the processing to step Sd13.

Consequently, about the range of the blocking direction blocked by the unobstructed view range, the intersection detection unit 146d does not perform the processing in steps Sd6, Sd7, and Sd8.

(Conditions for Starting Processing about the Next Base Station Candidate Position Data)

When determining in step Sd12 explained above that the calculated blocking angle is equal to or larger than the predetermined threshold, that is, determining Yes in step Sd12, the blocking-direction detection unit 143d advances the processing to step Sd17. When determining in step Sd15 that the number of times of division of the rotation angle interval is equal to or larger than the predetermined threshold “19” (Step Sd15—Yes), the detection-direction setting unit 148 advances the processing to step Sd17.

The data acquisition unit 140 determines whether the evaluation is performed about all the base stations. That is, the data acquisition unit 140 determines whether i is equal to or larger than N (step Sd17). When determining that i is not equal to or larger than N (step Sd17—No), the data acquisition unit 140 adds 1 to i and selects the next base station candidate position data (step Sd18). Thereafter, the processing in step Sd3 and subsequent steps is performed. On the other hand, when determining that i is equal to or larger than N (step Sd17—Yes), the data acquisition unit 140 ends the processing.

Note that, when the processing is advanced to step Sd18, data such as an unobstructed view range for each of buildings corresponding to the “i=1”-th base station candidate position data is stored in the data storage unit 15. Accordingly, the data is copied to other storage regions as data corresponding to the “i=1”-th base station candidate position data. The data storage unit 15 is initialized.

In the unobstructed-view-determination processing unit 14d in the fourth embodiment explained above, the detection-direction setting unit 148 sets, as a designated detection direction, one direction determined in advance around the position of the base station candidate position data and sets, as an auxiliary detection direction, an angle rotated at a predetermined rotation angle interval with respect to the designated detection direction. The intersection detection unit 146d detects an intersection with a contour line of a building that a straight line extended in the designated detection direction or the auxiliary detection direction starting from the position of the base station candidate position data crosses first. The intersection detection unit 146d detects intersection data indicating a coordinate of the detected intersection, line segment identification data indicating to which side of the building the intersection belongs, and building identification data indicating a building in which the intersection is present. When two or more intersections detected by the intersection detection unit 146d are present in the same building, the blocking-direction detection unit 143d detects the range of the blocking direction based on the designated detection direction or the auxiliary detection direction at the time when each of the intersections is detected. The unobstructed-view-range detection unit 144d extracts intersection data in which the building identification data is the same and the line segment identification data is the same. Subsequently, the unobstructed-view-range detection unit 144d generates a line segment connecting coordinates of the intersection data included in the extracted combination. The unobstructed-view-range detection unit 144d detects the generated line segment as an unobstructed view range of a building corresponding to the building identification data. When the angle of the auxiliary detection direction is 360° or more, the detection-direction setting unit 148 sets a half angle of the predetermined rotation angle interval as a new predetermined rotation angle interval and sets, as an auxiliary detection direction, an angle rotated at the new predetermined rotation angle interval in the designated detection direction. When the direction of the designated detection direction or the auxiliary detection direction is included in the range of the blocking direction, the intersection detection unit 146d does not perform detection of an intersection.

With the configuration in the fourth embodiment explained above, as in the first to third embodiments, it is possible to narrow down, on a map, candidates of buildings in which terminal stations are installed. Therefore, it is possible to greatly reduce determination processing with the point group data information. In The processing for narrowing down, on map data, the candidates of the buildings in which the terminal stations are installed, not all of the buildings have to be evaluated one by one. That is, every time the unobstructed view detection line is rotated once, halving the rotation angle interval, which is an interval for rotating the unobstructed view detection line, with 360° as an initial value is repeated to rotate the unobstructed view detection line and an intersection crossing the building first is detected. In that case, the detection of an intersection is not performed about the same direction. Further, in a certain building, when an unobstructed view range is detected, the detection of an intersection is not performed about a direction included in a range of a direction including the unobstructed view range, that is, the range of the blocking direction. Therefore, it is possible to efficiently perform the detection of the unobstructed view range.

A reason for setting the threshold in step Sd12 to “19” in the fourth embodiment explained above is explained. As explained in the third embodiment, length in which detection of an unobstructed view range is necessary on a wall of a building present in a boundary of a communicable range needs to be set to a value exceeding an antenna size of a radio device set on a wall surface of the building as a terminal station. For example, a size of approximately 8.7 cm is assumed as an antenna size and a size of approximately 10 cm is assumed as a size of the radio device in that case. It is assumed that a communication distance is, for example, 100 m. At this time, when the rotation angle interval is divided eighteen times, the length between ends of unobstructed view detection lines 100 m ahead, that is, the length of a wall surface of a building to be detected is 100 m×360°÷(2¹⁸)=13.7 cm. When the rotation angle interval is divided nineteen times, the length of a wall surface of a building to be detected is 100 m×360°+(2¹⁹)=6.9 cm. Therefore, whereas the length of approximately 10 cm, which is the length in which the detection of the unobstructed view range is necessary, cannot be detected when the rotation angle interval is divided eighteen times, the length of approximately 10 cm can be detected by dividing the rotation angle interval nineteen times. Therefore, “19” is determined in advance as the threshold.

Note that, in the fourth embodiment explained above, the north direction is decided as the designated detection direction. However, any direction may be set as the designated detection direction. In the fourth embodiment, “360°” is applied as the initial value of the rotation angle interval. However, the rotation angle interval may be an angle other than “360°”.

Dividing the rotation angle interval nineteen times and setting the length of the wall surface of the building to be detected to 6.9 cm as explained above is equivalent to setting the unobstructed view detection line at an interval of an angle of 6.9 cm÷3.14÷100 m×360° 0.08°, that is, an angle of 0.1° or less around the utility pole 40. Therefore, in the fourth embodiment, the processing for one base station ends according to two conditions. One condition is a condition that, as in the third embodiment, in step Sd12, the processing is ended on condition that the blocking angle is 355° or more. The other condition is a condition that, in step Sd15, the processing is ended when the rotation angle interval of the unobstructed view detection line is 0.1° or less.

Note that, in the third embodiment, in step Sc13, the angle in the range of the direction in which a building is absent is added to the blocking angle and, then, it is determined whether the added-up value is 355° or more. In the fourth embodiment, similarly, in step Sd12, the angle in the range of the direction in which a building is absent may be added to the blocking angle and, then, it may be determined whether the added-up value is 355° or more. This makes it possible to allow the detection processing not to be performed at accuracy more than requested. However, in the fourth embodiment, since the condition in step Sd15 is present, even if the angle in the range of the direction in which a building is absent is not added to the condition in step Sd12, the processing is surely ended by the condition in step Sd15 even if the blocking angle is not 355° or more as the processing progresses.

### Fifth Embodiment

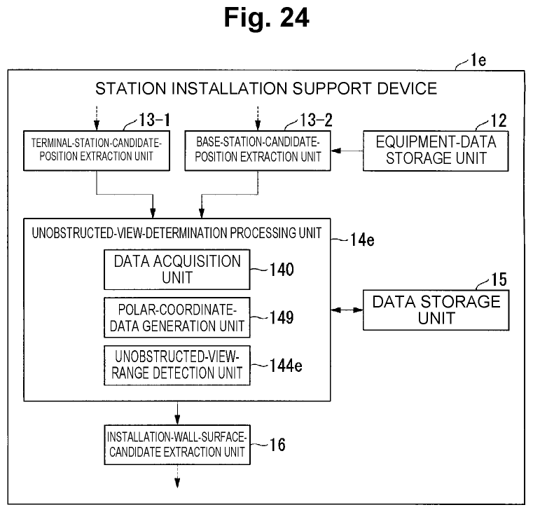

FIG. 24 is a block diagram showing the configuration of a station installation support device 1e according to a fifth embodiment. In the fifth embodiment, the same components as the components in the basic embodiment and the first to fourth embodiments are denoted by the same reference numerals and signs. Different components are explained below. The station installation support device 1e has a configuration in which the unobstructed-view-determination processing unit 14 is replaced with an unobstructed-view-determination processing unit 14e in the station installation support device 1 in the basic embodiment.

The unobstructed-view-determination processing unit 14e includes the data acquisition unit 140, a polar-coordinate-data generation unit 149, and an unobstructed-view-range detection unit 144e. The polar-coordinate-data generation unit 149 captures base station candidate position data output by the data acquisition unit 140 and building contour data for each of buildings. The polar-coordinate-data generation unit 149 generates, based on data indicating coordinates of a plurality of vertexes included in the building contour data for each of the buildings and data indicating an adjacency relation among the vertexes, for each of the buildings, contour line data of an orthogonal coordinate system indicating the shape of the building.

The polar-coordinate-data generation unit 149 converts the generated contour line data of the orthogonal coordinate system for each of the buildings into contour line data of a polar coordinate system based on a position indicated by the base station candidate position data. The contour line data of the polar coordinate system is data represented by a direction of a contour line for each of the buildings based on the position indicated by the base station candidate position data and a distance from the position indicated by the base station candidate position data to the contour line.

The unobstructed-view-range detection unit 144e selects buildings in order from the building at the shortest distance from the position indicated by the base station candidate position data. The unobstructed-view-range detection unit 144e extracts contour line data of a polar coordinate system of the selected building. The unobstructed-view-range detection unit 144e extracts a portion having the smallest value of a distance among the extracted contour line data of the polar coordinate system and contour line data of polar coordinate systems of the other buildings in respective directions. The unobstructed-view-range detection unit 144e detects the extracted portion as an unobstructed view range of the building.

When the selected building is entirely blocked by an already detected unobstructed view range, the unobstructed-view-range detection unit 144e does not perform detection of an unobstructed view range about the selected building.

### (Processing by the Station Installation Support Device in the Fifth Embodiment)

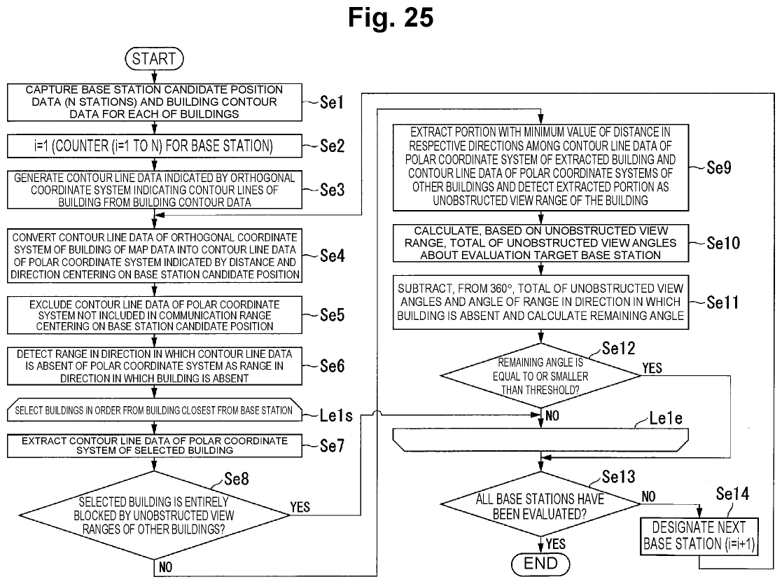

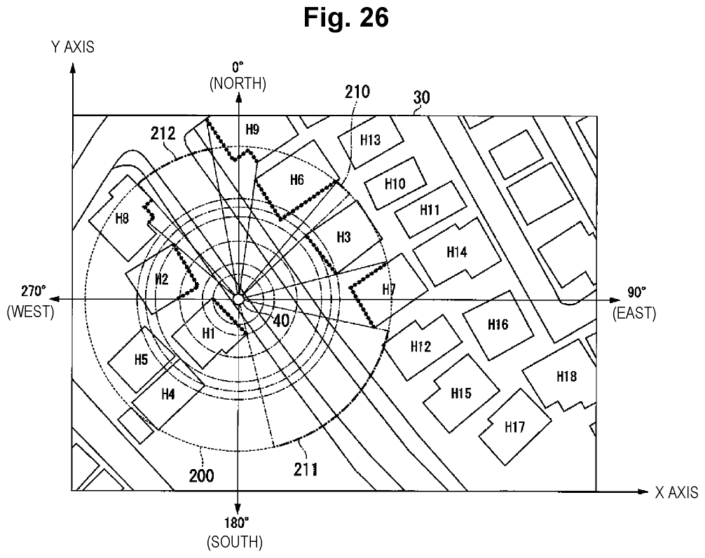

Subsequently, processing by the station installation support device 1e in the fifth embodiment is explained with reference to FIG. 25 to FIG. 27. FIG. 25 is a flowchart showing a flow of processing of a station installation support method by the station installation support device 1e.

About step Se1 and step Se2, the same processing as the processing in step Sa1 and step Sa2 in the first embodiment is performed by the data acquisition unit 140.

The polar-coordinate-data generation unit 149 captures the “i=1”-th base station candidate position data output by the data acquisition unit 140 and the building contour data for each of the buildings. The polar-coordinate-data generation unit 149 generates, based on the data indicating the coordinate of the plurality of vertexes included in the building contour data for each of the buildings and the data indicating the adjacency relation among the vertexes, for each of the buildings, contour line data of an orthogonal coordinate system indicating the shape of the building (step Se3).

For example, in the case of the map data 30, when the horizontal axis is represented as an X axis and the vertical axis is represented as a Y axis as shown in FIG. 26, the contour line data of the orthogonal coordinate system for each of the buildings generated by the polar-coordinate-data generation unit 149 is data of a line segment indicated by an orthogonal coordinate system of an XY coordinate.

The polar-coordinate-data generation unit 149 converts, based on the position indicated by the “i=1”-th base station candidate position data, the generated data of the contour line of the orthogonal coordinate system for each of the buildings into, for example, a polar coordinate system in which the north direction is set as 0° in FIG. 26 and generates contour line data of the polar coordinate system (step Se4).

Note that, as shown in FIG. 26, in the map data 30, directions are decided such that an angle increases clockwise to be 90° in the east direction, 180° in the south direction, and 270° in the west direction. The position indicated by the “i=1”-th base station candidate position data is the position of the utility pole 40.

The contour line data of the polar coordinate system is based on the position of the utility pole 40 and represented by a direction of a contour line for each of the buildings in which the north direction is set to 0° and a distance to the contour line.

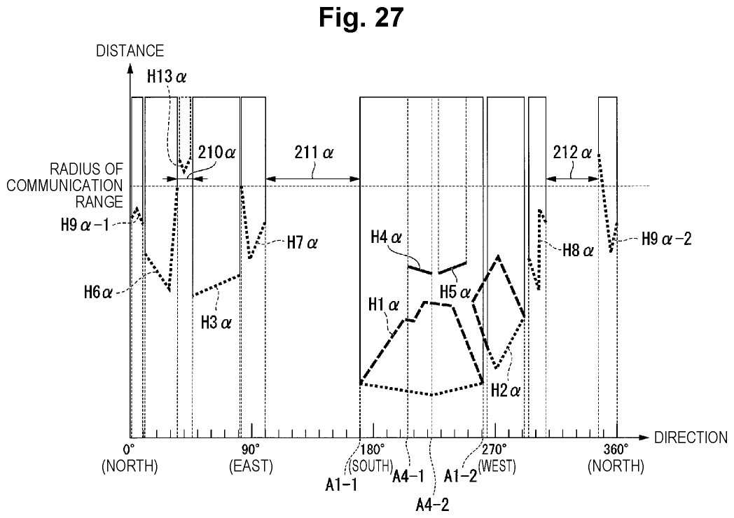

When the contour line data of the polar coordinate system generated by the polar-coordinate-data generation unit 149 is represented as a graph in which the horizontal axis indicates a direction and the vertical axis indicates a distance and the horizontal axis and the vertical axis are orthogonal, a graph shown in FIG. 27 is obtained. In FIG. 27, for example, a building H1α is the building H1 indicated by the contour line data of the polar coordinate system and a building H2α is the building H2 indicated by the contour line data of the polar coordinate system.

Portions indicated by signs of buildings H3α to H8α and a building H13α are respectively portions of the buildings H3 to H8 and the building H13 indicated by the contour line data of the polar coordinate system. Buildings H9α-1 and H9α-2 are portions of the building H9 indicated by the contour line data of the polar coordinate system. In the following explanation, the buildings H9α-1 and H9α-2 are collectively referred to as building H9α as well.

The unobstructed-view-range detection unit 144e excludes contour line data of the polar coordinate system not included in a communication range in which wireless communication is possible around the position of the utility pole 40 (step Se5). For example, in FIG. 26, it is assumed that the communication range that is centered on the utility pole 40 is a range in a circle indicated by a sign 200. When the circle indicated by the sign 200 is shown in the graph of FIG. 27, the circle is a straight line indicated by “distance=the radius of the communication range”. Therefore, the unobstructed-view-range detection unit 144e excludes contour line data of the polar coordinate system in which a value of the distance exceeds the radius of the communication range. Consequently, the contour line data of the polar coordinate system other than the buildings H1α to H9α is excluded. For example, among the buildings H1α to H9α and the building H13α shown in FIG. 27, the building H13α is excluded.

The unobstructed-view-range detection unit 144e detects, as ranges in directions in which buildings are absent, ranges in directions in which the contour line data of the polar coordinate system are absent (step Se6). In FIG. 27, the unobstructed-view-range detection unit 144e detects ranges of signs 210α, 211α, and 212α as ranges in directions in which buildings are absent. The ranges of the signs 210α, 211α, and 212α are shown as ranges of signs 210, 211, and 212 in FIG. 26.

The unobstructed-view-range detection unit 144e selects buildings one by one in order from the building closest from the position of the utility pole 40 and performs processing in steps Se7 to Se10 (loops Le1s to Le1e). The unobstructed-view-range detection unit 144e detects, for example, based on the contour line data of the polar coordinate systems of the buildings, a position at the shortest distance from the utility pole 40 in the contour line data of each of the buildings. The unobstructed-view-range detection unit 144e selects the buildings one by one in order from the building in the detected position at the shortest distance and at the shortest length of the distance to the utility pole 40 to select the buildings in order from the building closest from the position of the utility pole 40.

The unobstructed-view-range detection unit 144e extracts the contour line data of the polar coordinate system of the selected building (step Se7). It is assumed that, first, the unobstructed-view-range detection unit 144e selects the building H1 and extracts the building H1α, which is the contour line data of the polar coordinate system of the building H1.

The unobstructed-view-range detection unit 144e refers to the data storage unit 15 and determines whether the selected building is entirely blocked by unobstructed view ranges of the other buildings (step Se8). When determining that the selected building is entirely blocked by the unobstructed view ranges of the other buildings (step Se8—Yes), the unobstructed-view-range detection unit 144e does not perform processing in step Se9 and subsequent steps about the selected building, selects a building second closest to the position indicated by the base station candidate position data, and performs the processing in step Se7 and subsequent steps.

On the other hand, when determining that the selected building is not entirely blocked by the unobstructed view range of the other buildings (step Se8—No), the unobstructed-view-range detection unit 144e extracts a portion where a value of a distance of the contour line data of the extracted building H1α among the contour line data of the polar coordinate systems of all the buildings is the smallest in respective directions occupied by the building H1α. As shown in FIG. 27, the building H1α, which is the contour line data of the polar coordinate system of the building H1, occupies ranges of A1-1 to A1-2 in coordinates of the directions. The building H1α includes line segments of a dotted line and a broken line. The portion where the value of the distance is the smallest in the respective directions is a portion of the dotted line.

Therefore, the unobstructed-view-range detection unit 144e detects the line segment of the portion of the dotted line of the building H1α as the unobstructed view range of the building H1. The unobstructed-view-range detection unit 144e writes the building identification data of the building H1 and data indicating the unobstructed view range, that is, contour line data of a polar coordinate system of the portion of the unobstructed view range in the data storage unit 15 and causes the data storage unit 15 to store the data (step Se9).

The unobstructed-view-range detection unit 144e calculates a total of unobstructed view angles based on the data indicating all the unobstructed view ranges stored by the data storage unit 15 (step Se10). For example, in the case of the building H1, the unobstructed-view-range detection unit 144e reads, from the data storage unit 15, a minimum value A1-1 and a maximum value A1-2 of a direction axis from the data indicating the unobstructed view ranges and subtracts the read minimum value A1-1 from the read maximum value A1-2 to calculate an unobstructed view angle about the building H1. The unobstructed-view-range detection unit 144e calculates unobstructed view angles based on all the unobstructed view ranges stored by the data storage unit 15 and calculates a total of all the calculated unobstructed view angles.

The unobstructed-view-range detection unit 144e subtracts, from 360°, a calculated total value of the unobstructed view angles and the angles of the ranges in the directions in which buildings are absent detected in step Se6 and calculates the remaining angle (step Se11). The unobstructed-view-range detection unit 144e determines whether the calculated remaining angle is equal to or smaller than a threshold (step Se12). As the threshold, for example, “a value of 0.1° or less” is applied.

When determining that the remaining angle is not equal to or smaller than the threshold (step Se12—No), subsequently, the unobstructed-view-range detection unit 144e performs the processing in step Se7 and subsequent steps for selecting the building H2 close from the position of the utility pole 40.

On the other hand, when determining that the remaining angle is equal to or smaller than the threshold (step Se12 —Yes), even if an unobstructed view range of the remaining angle is detected, since the unobstructed view range is not length sufficient for setting an antenna of a radio device, the unobstructed-view-range detection unit 144e skips the processing in the loops Le1s to Le1e and proceeds to processing in step Se13.

The data acquisition unit 140 determines whether evaluation is performed about all the base stations. That is, the data acquisition unit 140 determines whether i is equal to or larger than N (step Se13). When determining that i is not equal to or larger than N (step Se13—No), the data acquisition unit 140 adds 1 to i and select the next base station candidate position data (step Se14). The processing in step Se4 and subsequent steps is performed. On the other hand, when determining that i is equal to or larger than N (step Se13—Yes), the data acquisition unit 140 ends processing.

Note that, when the processing is advanced to step Se14, data such as unobstructed view ranges for each of the buildings corresponding to the “i=1”-th base station candidate position data is stored in the data storage unit 15. Therefore, the data is copied to other storage regions as data corresponding to the “i=1”-th base station candidate position data. The data storage unit 15 is initialized.

By repeating the processing in the loops Le1s to Le1e, about the building H2, processing explained below is performed in step Se9 through step Se7 and step Se8 (a determination result: No). As shown in FIG. 27, contour line data of a polar coordinate system of the building H2 is represented as the building H2α. A part of a broken line of the building H2α is present in the same direction as the direction of the building H1α. A value of a distance of this portion is larger than a value of a distance of the building H1α and is not a smallest value. Therefore, this portion is not an unobstructed view range. In the other portion of the broken line of the building H2α, a distance of the portion is not the smallest in the building H2α. In a portion of a dotted line of the building H2α, a value of a distance of the portion is the smallest.

Therefore, the unobstructed-view-range detection unit 144e detects the portion of the dotted line of the building H2α as an unobstructed view range of the building H2. Similarly, the unobstructed-view-range detection unit 144e detects an unobstructed view range of the building H3. Note that, in FIG. 27, not the entire building H3α but only a portion of an unobstructed view range of contour line data of a polar coordinate system of the building H3 is indicated by a dotted line.

The unobstructed-view-range detection unit 144e selects the building H4 next. The building H4α, which is contour line data of a polar coordinate system of the building H4, is present in a range of a direction A4-1 to A4-2 as shown in FIG. 27. At this time, data indicating the unobstructed view range of the building H1 is already stored in the data storage unit 15. The minimum value A1-1 and the maximum value A1-2 of the direction axis of the unobstructed view range of the building H1 can be detected from the data. It is already known that a value of a distance of the unobstructed view range of the building H1 is the shortest distance from the utility pole 40.

Therefore, in step Se8, if A1-1≤A4-1 and A4-2≤A1-2 are satisfied, irrespective of a value of a distance, the unobstructed-view-range detection unit 144e can easily determine that the building H4 is blocked by the unobstructed view range of the building H1. Therefore, about the building H4, the unobstructed-view-range detection unit 144e determines that the entire building H4 is blocked by the unobstructed view range of the other building H1 (step Se8—Yes) and selects the second closest building H5. The processing in step Se7 and subsequent steps is performed.

In this way, the unobstructed-view-range detection unit 144e respectively detects, as the unobstructed view ranges of the buildings H1, H2, H3, H6, H7, H8, and H9, as shown in FIG. 27, the portions of the dotted lines of the buildings H1α and H2α and the portions indicated by the buildings H3α, H6α, H7α, H8α, and H9α.

Note that, with the configuration in the fifth embodiment explained above, the buildings are selected in order from the building closest to the utility pole 40. However, the present invention is not limited to the embodiment. As shown in the graph of FIG. 27, if portions at the shortest distances in the respective directions are extracted in the contour line data of the polar coordinate systems, the portions can be detected as unobstructed view ranges. By performing the processing in this way, it is possible to exclude, without performing particular processing, the portions blocked by the unobstructed view ranges. By dividing the detected unobstructed view ranges for each of the buildings in this way, it is possible to detect the unobstructed view ranges for each of the buildings.

In the unobstructed-view-determination processing unit 14e in the fifth embodiment explained above, the polar-coordinate-data generation unit 149 generates, for each of the buildings, contour line data of orthogonal coordinate systems indicating contour lines of the buildings included in the map data and converts the generated contour line data of the orthogonal coordinate systems for each of the buildings into contour line data of polar coordinate systems indicated by distances and directions based on a base station candidate position. The unobstructed-view-range detection unit 144e extracts the contour line data of the polar coordinate systems in portions at the shortest distances from the base station candidate position in the respective directions, divides the extracted contour line data of the polar coordinate systems for each of the buildings, and detects the contour line data of the polar coordinate systems divided for each of the buildings as unobstructed view ranges for each of the buildings.

With the configuration in the fifth embodiment explained above, as in the first to fourth embodiment, since it is possible to narrow down, on a map, candidates of buildings in which the terminal stations are installed, it is possible to greatly reduce the determination processing with the point group data information. In processing for narrowing down, on map data, the candidates of the buildings in which the terminal stations are installed, not all of the buildings have to be evaluated one by one. That is, by extracting the portions at the shortest distances in the respective directions of the contour line data of the polar coordinate systems, it is possible to exclude a portion blocked by an unobstructed view range of a certain building and easily detect unobstructed view ranges for each of the buildings without including functional units such as the blocking-direction detection units 143, 143b, 143c, and 143d included in each of the first to fourth embodiments and calculating ranges of blocking directions.

Note that the threshold in step Se12 in the fifth embodiment explained above is set to “a value of 0.1° or less”. A ground for this is the same reason as the reason explained in the third and fourth embodiments. That is, length in which detection of an unobstructed view range is necessary on a wall of a building present in a boundary of a communicable range needs to be set to a value exceeding an antenna size of a radio device set on a wall surface of the building as a terminal station. For example, a size of approximately 8.7 cm is assumed as an antenna size and a size of approximately 10 cm is assumed as a size of the radio device in that case. It is assumed that a communication distance is, for example, 100 m. In this case, as explained in the third and fourth embodiments, therefore, even if an unobstructed view range is detected at an angle interval of 0.1° or less, since an antenna cannot be set in the unobstructed view range, it is unnecessary to detect the unobstructed view range.

### (Another Configuration Example of the First and Third Embodiments)

The unobstructed-view-range detection units 144 and 144c in the first and third embodiments explained above perform the detection of the unobstructed view range, for example, with the method described in Patent Literature 1. An overview of the method described in Patent Literature 1 is explained.

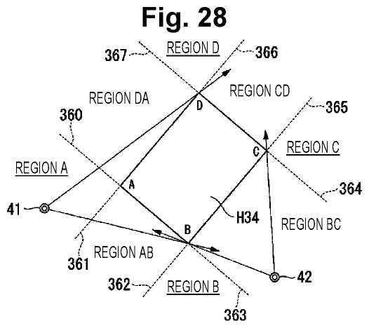

Patent Literature 1 discloses a method of detecting candidates of wall surfaces having unobstructed views when viewed from a region around a building. For example, as shown in FIG. 28, when vertexes of the shape of a building H34 are represented as A, B, C, and D, sides, that is, wall surfaces forming the contour of the building H34 are indicated by a wall surface AB, a wall surface BC, a wall surface CD, and a wall surface DA. At this time, the periphery of the building can be divided into eight regions, that is, regions A, AB, B, BC, C, CD, D, and DA by auxiliary lines 360 to 367 obtained by extending line segments of the wall surface AB, the wall surface BC, the wall surface CD, and the wall surface DA.

The eight regions can be classified into two types according to the number of wall surfaces having unobstructed views. Two wall surfaces have unobstructed views from each of the underlined regions A, B, C, and D, each of which is divided by two of the auxiliary lines 360 to 367. For example, when a utility pole 41 is set in the region A, the wall surface AB and the wall surface DA can be viewed without obstruction. In contrast, only one wall surface can be viewed without obstruction from each of regions AB, BC, CD, and DA, each of which is divided by one of contour lines of the building H34 and two of the auxiliary lines 360 to 367. For example, when a utility pole 42 is set in the region BC, only the wall surface BC can be viewed without obstruction. In this way, by dividing the region around the building H34 in advance and detecting to which region the position of a utility pole belongs, it is possible to easily indicate candidates of wall surfaces on which terminal states are installed.

However, the method described in Patent Literature 1 can be applied when the shape of a building is a rectangle but cannot be applied when the shape of the building is a shape more complicated than the rectangle.

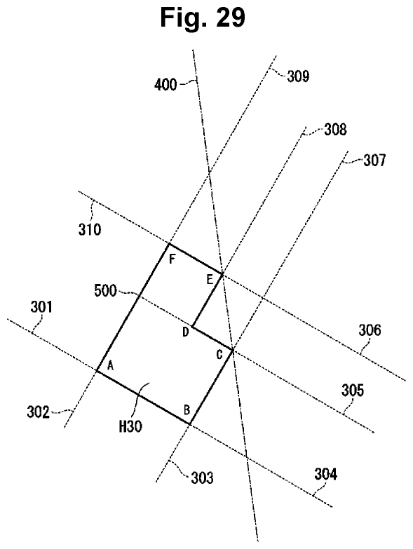

Accordingly, for example, in the case of the shape of a building H30 shown in FIG. 29, that is, a shape having a projecting part obtained by combining a rectangular shape formed by vertexes D, E, and F and a point indicated by a sign 500 with a rectangular shape formed by vertexes A, B, and C and the point indicated by the sign 500, detection of an unobstructed view range cannot be performed by the method described in Patent Literature 1. Note that, in the case of the building H30, the projecting part is equivalent to the rectangular shape formed by the vertexes D, E, and F and the point indicated by the sign 500. Note that the point indicated by the sign 500 is an intersection where an extended straight line of a side CD and a side FA cross.

In the following explanation, for convenience of explanation, only a portion of a configuration for detecting an unobstructed view range of a building included in the configuration of the unobstructed-view-range detection units 144 and 144c in the first and third embodiments is explained as an unobstructed-view-range detection unit 144f.

When the shape of a building is a shape having a projecting part obtained by combining a rectangular shape with a rectangular shape like the building H30, as shown in FIG. 29, the unobstructed-view-range detection unit 144f sets auxiliary lines 301 to 310 obtained by extending the sides of the building H30 and an auxiliary line 400 obtained by extending a line connecting the vertex F of the projecting part and another vertex C of the building viewed without obstruction from the vertex F of the projecting part through the outside of the region of the building H30. The unobstructed-view-range detection unit 144f detects an unobstructed view range of the building H30 based on a plurality of regions obtained by dividing the region around the building H30 with the auxiliary lines 301 to 310 and the auxiliary line 400 and a position indicated by base station candidate position data. When the shape of a building is a rectangular shape, the unobstructed-view-range detection unit 144f detects an unobstructed view range based on the method described in Patent Literature 1.

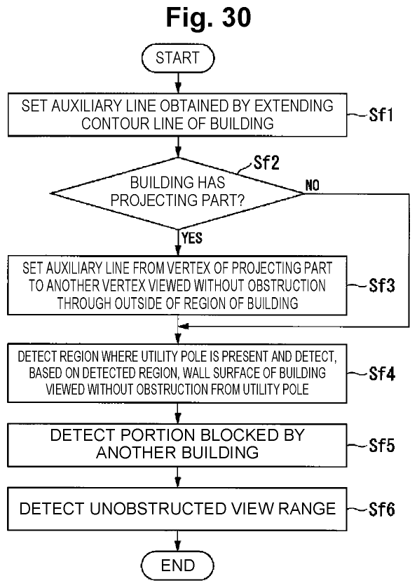

Processing of the unobstructed-view-range detection unit 144f is explained below with reference to FIG. 30 to FIG. 32. FIG. 30 is a flowchart showing a flow of the processing of the unobstructed-view-range detection unit 144f.

The unobstructed-view-range detection unit 144f sets the auxiliary lines 301 to 310 obtained by extending the contour lines of the building H30 (step Sf1). The unobstructed-view-range detection unit 144f determines whether the building H30 has a projecting part (step Sf2). When determining that the building H30 does not have a projecting part (step Sf2—No), the unobstructed-view-range detection unit 144f advances the processing to step Sf4.

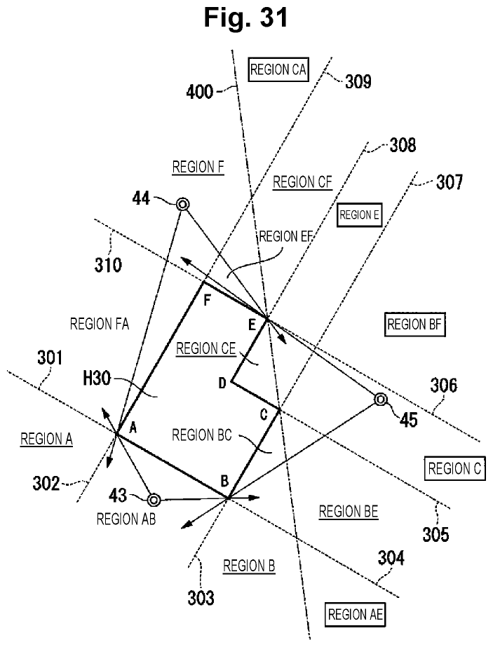

On the other hand, when determining that the building H30 has a projecting part (step Sf2—Yes), the unobstructed-view-range detection unit 144f sets an auxiliary line obtained by extending a line connecting a vertex of the projecting part and another vertex of the building viewed without obstruction from the vertex of the projecting part through the outside of the region of the building H30 (step Sf3). As shown in FIG. 31, in the case of the building H30, the vertex C viewed without obstruction from the vertex E among the vertexes of the projecting part through the outside of the region of the building H30 is present. Therefore, the auxiliary line 400 is set between the vertex E and the vertex C.

The region on the outside of the building H30 is divided into fifteen regions of regions AB, BC, EF, and FA, regions A, B, BE, CE, CF, and F, and regions AE, C, BF, E, and CA by the auxiliary lines 301 to 310 and the auxiliary line 400. The fifteen regions can be classified into three types.

The regions AB and FA are regions, each of which is divided by a contour line of any one side of the building H30 and any two of the auxiliary lines 301 to 310. The regions BC and EF are regions, each of which is surrounded by a contour line of any one side of the building H30, any one of the auxiliary lines 301 to 310, and the auxiliary line 400. When a utility pole is located in any one of these regions, a wall surface to be an unobstructed view range is one place. For example, when a utility pole 43 is located in the region AB, the wall surface AB of the building H30 is an unobstructed view range.

The underlined regions A, B, BE, CF, and F are regions, each of which are divided by two of the auxiliary lines 301 to 310 or any two of the auxiliary lines 301 to 310 and the auxiliary line 400, and are regions, only one of vertexes of each of which coincides with any one of the vertexes of the building H30. The underlined region CE is a region surrounded by two wall surfaces of the building H30 and two of the auxiliary lines 301 to 310. When a utility pole is located in the underlined region, wall surfaces to be unobstructed view ranges are two places. For example, when a utility pole 44 is located in the region F, the wall surface EF and the wall surface FA of the building H30 are unobstructed view ranges.

The regions AE, BF, and CA shown with frames are regions, each of which is divided by any one of the auxiliary lines 301 to 310 and the auxiliary line 400, and are regions, all of vertexes of regions of each of which do not coincide with the vertexes of the building H30. The region C and E shown with a frame is a region divided by three of the auxiliary lines 301 to 310 and is a region, only one of vertexes of which coincides with any one of the vertexes of the building H30. When a utility pole is located in the region shown with the frame, wall surfaces to be unobstructed view ranges are three or more places. For example, when a utility pole 45 is located in the region C, the wall surface BC, the wall surface CD, and the wall surface DE are unobstructed view ranges.

The unobstructed-view-range detection unit 144f detects, based on the position indicated by the base station candidate position data, in which of a region divided by contour lines of a building or set auxiliary lines or a region surrounded by contour lines of the building or set auxiliary lines a utility pole is present. The unobstructed-view-range detection unit 144f detects, based on the detected region where the utility pole is present, a wall surface of the building viewed without obstruction from the utility pole (step Sf4). For example, in the case of the utility pole 45, the unobstructed-view-range detection unit 144f detects that the utility pole 45 is present in the region C and detects the wall surface BC, the wall surface CD, and the wall surface DE based on the detected region C.

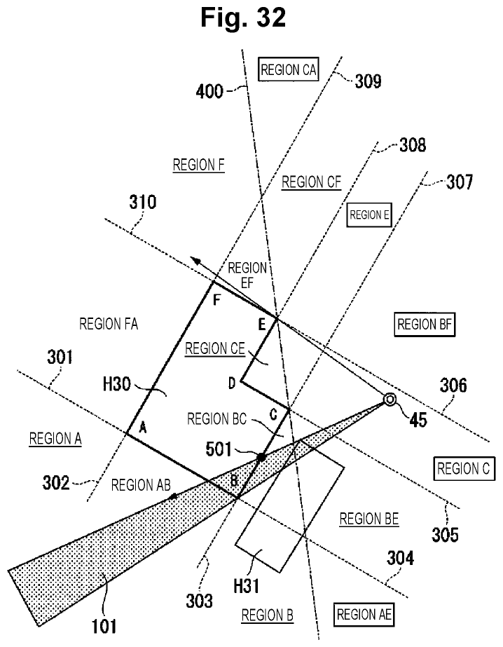

The unobstructed-view-range detection unit 144f detects a portion blocked by another building (step Sf5). For example, when a building H31 is present as shown in FIG. 32, a region 101 is a region blocked by the building H31. At this time, on the wall surface BC of the building H30, a portion between the vertex B and a point indicated by a sign 501 cannot be viewed without obstruction from the utility pole 45. Note that, in the first and third embodiments, since a range in a blocked direction is stored in the data storage unit 15, the unobstructed-view-range detection unit 144f refers to the data storage unit 15 and acquires data concerning the region 101.

The unobstructed-view-range detection unit 144f detects, as unobstructed view ranges of the building H30 in the case of the utility pole 45, ranges obtained by excluding a portion between the vertex B of the building H30 detected in step Sf5 and the point indicated by the sign 501 from the wall surface BC, the wall surface CD, and the wall surface DE detected in step Sf4, that is, a wall surface between the point indicated by the sign 501 and the vertex C, the wall surface CD, and the wall surface DE (step Sf6).

Note that, when determining No in step Sf2, in step Sf4, the unobstructed-view-range detection unit 144f detects a wall surface having an unobstructed view in the building based on the method described in Patent Literature 1.

(In the case of a building having a more complicated shape)

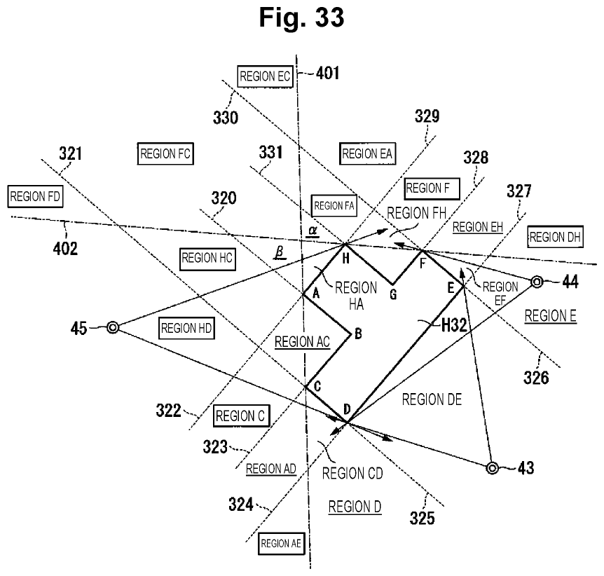

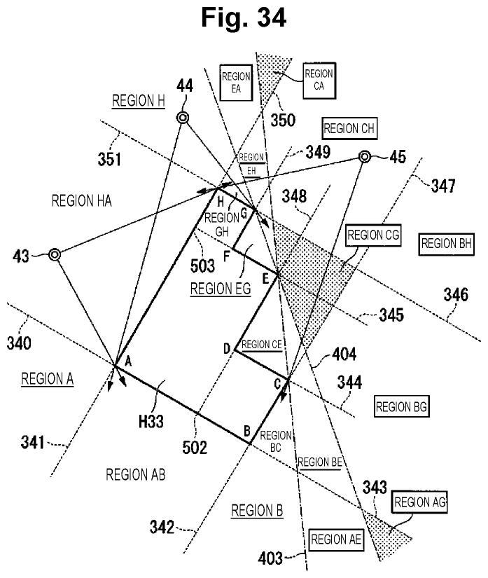

The shape of a building is assumed to be, for example, shapes shown in FIG. 33 and FIG. 34 as a shape having a projecting part obtained by combining a rectangular shape with a rectangular shape. A difference between the shapes shown in FIG. 33 and FIG. 34 and the shape shown in FIG. 31 is that there are two auxiliary lines obtained by extending lines connecting vertexes of a projecting part and other vertexes of a building viewed without obstruction from the vertex of the projecting part through the outside of the region of the building.

In the case of the shape of a building H32 shown in FIG. 33, when a projecting part is a portion having vertexes A, B, G, and H, the unobstructed-view-range detection unit 144f sets auxiliary lines 320 to 331 obtained by extending contour lines of the building H32. The unobstructed-view-range detection unit 144f sets an auxiliary line 401 obtained by extending a line connecting the vertex A and the vertex C of the projecting part and an auxiliary line 402 obtained by extending a line connecting the vertex H of the projecting part and a vertex F. Consequently, the region around the building H32 is divided into twenty-three regions. As in the case of the building H30, the twenty-three regions can be classified into three types.

A region DE is a region divided by a contour line of any one side of the building H32 and any two of the auxiliary lines 320 to 331. Regions CD, EF, and HA are regions, each of which is surrounded by a contour line of any one side of the building H32 and any two of the auxiliary lines 320 to 331 and the auxiliary lines 401 and 402 including at least one of the auxiliary lines 401 and 402. When a utility pole is located in any one of these regions, a wall surface to be an unobstructed view range is one place. For example, when the utility pole 43 is located in the region DE, only a wall surface DE of the building H32 is an unobstructed view range.

Underlined regions D, E, AD, and EH are regions, each of which are divided by any two of the auxiliary lines 320 to 331 and any one of the auxiliary lines 401 and 402, and are regions, only one of vertexes of each of which coincides with any one of the vertexes of the building H32. Underlined regions α and β are regions, each of which is surrounded by two of the auxiliary lines 401 and 402 and any one of auxiliary lines 340 to 351, and are regions, only one of vertexes of each of which coincides with any one of the vertexes of the building H32. Underlined regions AC and FH are regions, each of which is surrounded by two wall surfaces of the building H32 and two of the auxiliary lines 320 to 331. When a utility pole is located in any one of the underlined regions, wall surfaces to be unobstructed view ranges are two places. For example, when the utility pole 44 is located in the region E, the wall surface DE and a wall surface EF of the building H32 are unobstructed view ranges.

Regions AE, DH, EA, HD, EC, FD, and FC shown with frames are regions, each of which is divided by any one of the auxiliary lines 320 to 331 and the auxiliary lines 401 and 402, and are regions, all vertexes of each of which do not coincide with the vertexes of the building H32. Note that the region FC is a region divided by the auxiliary lines 330 and 321 and the auxiliary lines 401 and 402.

Regions C and F shown with frames are regions, each of which is divided by three of the auxiliary lines 320 to 331, and are regions, only one of vertexes of which coincides with any one of the vertexes of the building H32. Regions FA and HC shown with frames are regions, each of which is surrounded by three of the auxiliary lines 320 to 331 and one of the auxiliary lines 401 and 402, and are regions, only one of vertexes of which coincides with any one of the vertexes of the building H32. When a utility pole is located in any one of the regions shown with the frames, wall surfaces to be unobstructed view ranges are three or more places. For example, when the utility pole 45 is located in the region HD, a wall surface AB, a wall surface BC, a wall surface CD, and a wall surface HA are unobstructed view ranges.

In the case of the shape of a building H33 shown in FIG. 34, assuming that there are two projecting parts, similarly, a region on the outside of the building H33 is divided. The two projecting parts are a portion obtained by connecting vertexes B, C, and D and a point indicated by a sign 502 and a portion obtained by connecting vertexes F, G, and H and a point indicated by a sign 503. Note that the point indicated by the sign 502 is an intersection where a straight line of an extended side DE and a side AB cross and the point indicated by the sign 503 is an intersection where a straight line of an extended side EF and a side AH cross.

The unobstructed-view-range detection unit 144f sets auxiliary lines 340 to 351 obtained by extending contour lines of the building H33. The unobstructed-view-range detection unit 144f sets an auxiliary line 403 obtained by extending a line connecting the vertex C and a vertex E of the projecting part and an auxiliary line 404 obtained by extending a line connecting the vertex G and the vertex E of the projecting part. Consequently, the periphery of the building H33 is divided into nineteen regions. The nineteen regions can be classified into three types as in the cases of the buildings H30 and H32.

Regions AB and HA are regions, each of which is divided by a contour line of any one side of the building H33 and any two of the auxiliary lines 340 to 351. Regions BC and GH are regions, each of which is surrounded by a contour line of any one side of the building H33 and any two of the auxiliary lines 340 to 351 and the auxiliary lines 403 and 404 including at least one of the auxiliary lines 403 and 404. When a utility pole is located in any one of these regions, a wall surface to be an unobstructed view range is one place. For example, when the utility pole 43 is located in the region HA, only the wall surface HA of the building H33 is an unobstructed view range.

Underlined regions A, B, and H are regions, each of which is divided by two of the auxiliary lines 340 to 351 or any two of the auxiliary lines 340 to 351 and any one of the auxiliary lines 403 and 404, and are regions, only one of vertexes of which coincides with any one of the vertexes of the building H33. Underlined regions BE and EH are regions, each of which is surrounded by two of the auxiliary lines 403 and 404 and any two of the auxiliary lines 340 to 351, and are regions, only one of vertexes of which coincides with any one of vertexes other than the vertex E, which is an intersection of the two auxiliary lines 403 and 404, among the vertexes of the building H33.

Underlined regions CE and EG are different from the cases of the region CE shown in FIG. 31 and the regions AC and FH shown in FIG. 33. For example, the region CE is a region surrounded by two wall surfaces CD and DE, the auxiliary line 404 other than the auxiliary line 403 connecting the vertex C and the vertex E, which are the vertexes of the two wall surfaces CD and DE, and an auxiliary line 347 obtained by extending a wall surface BC. In contrast, the region EG is a region surrounded by two wall surfaces EF and FG, the auxiliary line 403 other than the auxiliary line 404 connecting the vertex E and the vertex G, which are the vertexes of the two wall surfaces EF and FG, and an auxiliary line 346 obtained by extending a wall surface GH.

In other words, the underlined regions CE and EG are regions, each of which is surrounded by two wall surfaces of the building H33, any one of the auxiliary lines 340 to 351, and an auxiliary line (in the case of the region CE, the auxiliary line 404 and, in the case of the region EG, the auxiliary line 403) generated by other projecting parts other than projecting parts sharing one of the two wall surfaces. When a utility pole is located in any one of the underlined regions, wall surfaces to be unobstructed view ranges are two places. For example, when the utility pole 44 is located in the region H, the wall surface GH and the wall surface HA of the building H33 are unobstructed view ranges.

Regions AE, AG, BG, BH, CH, CA, and EA shown with frames are regions, each of which are divided by the auxiliary lines 340 to 351 and the auxiliary lines 403 and 404, and are regions, all vertexes of which do not coincide with the vertexes of the building H33. Note that the region BG is a region divided by the auxiliary lines 343, 347, and 346 and the auxiliary line 404. The region CH is a region divided by the auxiliary lines 347, 346, and 350 and the auxiliary line 403.

A region CG shown with a frame is a region surrounded by the two auxiliary lines 403 and 404 and any one of the auxiliary lines 340 to 351 and is a region, only one of vertexes of which coincides with the vertex E, which is an intersection of the two auxiliary lines 403 and 404. When a utility pole is located in the region shown with the frame, wall surfaces to be unobstructed view ranges are three or more places. For example, when the utility pole 45 is located in the region CH, the wall surface CD, the wall surface DE, the wall surface EF, the wall surface GF, and the wall surface GH are unobstructed view ranges.

When the shape of a building is a shape having a projecting part obtained by combining a rectangular shape with a rectangular shape, the unobstructed-view-range detection unit 144f explained above detects an unobstructed view range of the building based on a plurality of regions obtained by dividing a region other than a region of the building with an auxiliary line obtained by extending a contour line of the building and an auxiliary line obtained by extending a line connecting a vertex of the projecting part and another vertex of the building viewed without obstruction from the vertex of the projecting part through the outside of the region of the building and based on a position indicated by base station candidate position data. Consequently, even when the shape of a building is a complicated shape having a projecting part obtained by combining a rectangular shape with a rectangular shape, detection of an unobstructed region can be performed. The unobstructed-view-range detection unit 144f also includes the configuration of the method described in Patent Literature 1. Accordingly, in the first and third embodiments, it is possible to perform the detection of an unobstructed view range about a building having, in addition to a rectangular shape, a shape slightly more complicated than the rectangular shape.

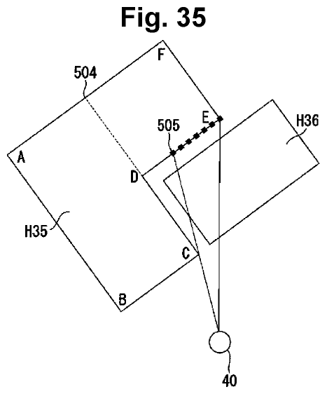

Note that, in the first and third embodiments, for example, it is assumed that the utility pole 40, a building H35, and a building H36 are disposed in a positional relation shown in FIG. 35. In the case of such a positional relation, when an unobstructed view range is detected from the building H35 at a short distance from the utility pole 40, at a point in time of the detection of the unobstructed view range of the building H35, a range in a direction blocked by an unobstructed view range of the building H36 is not detected. Accordingly, a wall surface between a part, that is, a vertex E of a wall surface DE of the building H35 and a point indicated by a sign 505 is erroneously detected as an unobstructed view range.

Accordingly, in such a case, the building H35 not having a rectangular shape is divided into a building having a rectangular shape formed by vertexes A, B, C, and G and a building having a rectangular shape formed by vertexes D, E, and F and a point indicated by a sign 504. Consequently, the building having the rectangular shape formed by the vertexes D E, and F and the point indicated by the sign 504 is present in a position farther from the position of the utility pole 40 than the building H36. Therefore, it is possible to prevent the wall surface between the vertex E and the point indicated by the sign 505 from being erroneously detected as an unobstructed view range.

For example, in the first and third embodiments, for example, when the data acquisition unit 140 captures the building contour data in step Sa1 and step Sc1, when building in the positional relation between the building H35 and the building H36 is present, if the building H35 is divided to have a rectangular shape, it is possible to prevent an unobstructed view range from being erroneously detected as explained above.

As another method, when the building H35 and the building H36 in the positional relation shown in FIG. 35 are present, the unobstructed-view-range detection units 144 and 144c may set the two of the building H35 and the building H36 as evaluation targets of an unobstructed view range and detect an unobstructed view range of the building H35 considering a range in a direction blocked by the building H36.

### Sixth Embodiment

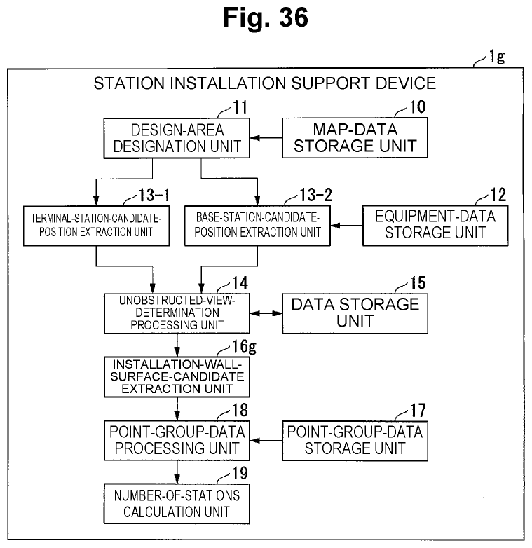

FIG. 36 is a block diagram showing the configuration of a station installation support device 1g in a sixth embodiment. In the sixth embodiment, the same components as the components in the basic embodiment and the first to fifth embodiments are denoted by the same reference numerals and signs. Different components are explained below. The station installation support device 1g has a configuration in which the installation-wall-surface-candidate extraction unit 16 is replaced with an installation-wall-surface-candidate extraction unit 16g in the station installation support device 1 in the basic embodiment.

The installation-wall-surface-candidate extraction unit 16g sets an auxiliary line obtained by extending a bisector of an interior angle of a building to the outside of a region of the building. The installation-wall-surface-candidate extraction unit 16g divides a region around the building with a straight line obtained by extending a contour line of the building or the contour line of the building. The installation-wall-surface-candidate extraction unit 16g detects, based on in which of divided regions a position indicated by base station candidate position data is present, a wall surface of the building to be a candidate of an installation position of a terminal station device in an unobstructed view range.

### (Processing of the Station Installation Support Device in the Sixth Embodiment)

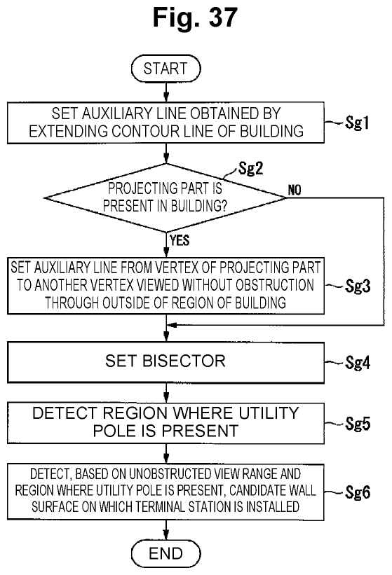

Subsequently, processing of the station installation support device 1g is explained with reference to FIG. 37 to FIG. 39. FIG. 37 is a flowchart showing a flow of the processing of the station installation support device 1g. Note that it is assumed that, before the processing shown in FIG. 37 is started, unobstructed view ranges for each of buildings are detected by the unobstructed-view-determination processing unit 14 in the basic embodiment, the unobstructed-view-range detection units 144a, 144b, 144c, 144d, and 144e in the first to fifth embodiments, or the unobstructed-view-range detection unit 144f in the other configuration examples of the first and third embodiment.

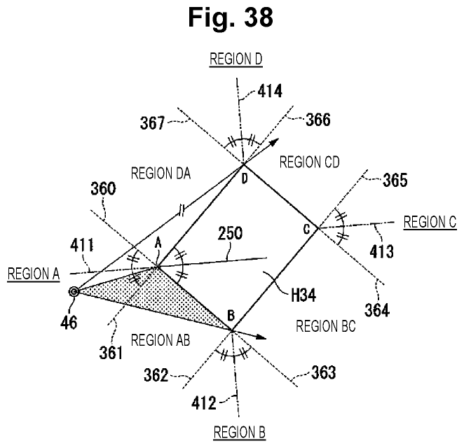

For example, it is assumed that the building H34 and a utility pole 46 are disposed in a positional relation shown in FIG. 38, a region blocked by other buildings is absent, and, as unobstructed view ranges of the building H34 from the utility pole 46, a wall surface AB and a wall surface DA of the building H34 are detected.

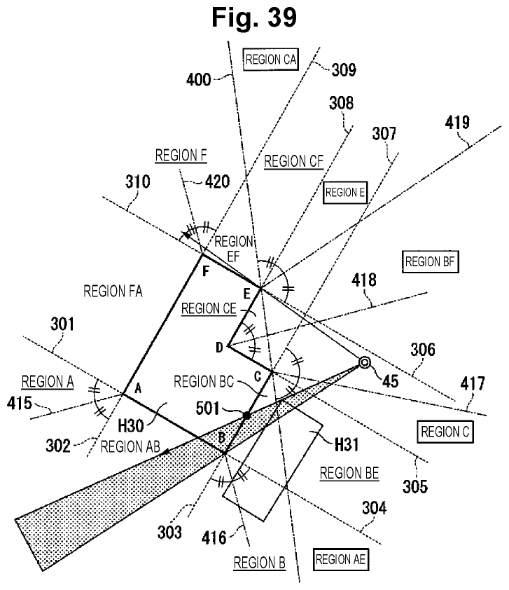

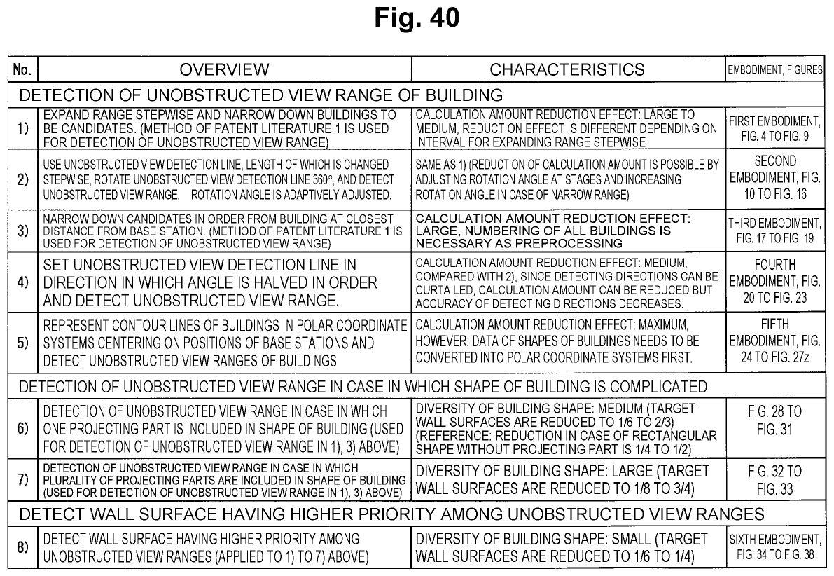

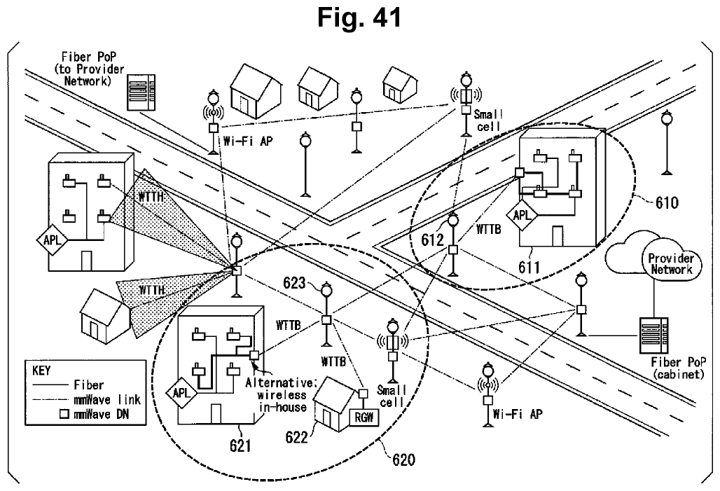

For example, it is assumed that the building H30, the building H31, and the utility pole 45 are disposed in a positional relation shown in FIG. 39, a part of the building H30 is blocked by the building H31, and, as unobstructed view ranges of the building H30 from the utility pole 45, a wall surface to the point indicated by the sign 501 and the vertex C, the wall surface CD, and the wall surface DE of the building H30 are detected.

The installation-wall-surface-candidate extraction unit 16g sets an auxiliary line obtained by extending a contour line of a building (step Sg1). The installation-wall-surface-candidate extraction unit 16g sets the auxiliary lines 360 to 367 about the building H34 shown in FIG. 38. The installation-wall-surface-candidate extraction unit 16g sets the auxiliary lines 301 to 310 about the building H30 shown in FIG. 39.

The installation-wall-surface-candidate extraction unit 16g determines whether the building has a projecting part (step Sg2). In the case of the building H34 shown in FIG. 38, the installation-wall-surface-candidate extraction unit 16g determines that the building H34 does not have a projecting part (step Sg2—No) and advances the processing to step Sg4.

On the other hand, in the case of the building H30 shown in FIG. 39, the installation-wall-surface-candidate extraction unit 16g determines that the building H34 has a projecting part (step Sg2—Yes) and sets an auxiliary line obtained by extending a line connecting a vertex of the projecting part and another vertex of the building viewed without obstruction from the vertex of the projecting part through the outside of the region of the building H30 (step Sg3). As shown in FIG. 39, in the case of the building H30, a vertex C viewed without obstruction from a vertex E among vertexes of the projecting part through the outside of the region of the building H30 is present. Therefore, the auxiliary line 400 is set between the vertex E and the vertex C.

The installation-wall-surface-candidate extraction unit 16g sets an auxiliary line obtained by extending a bisector of an interior angle of the building to the outside of the region of the building (step Sg4). In the case of the building H34 shown in FIG. 38, the installation-wall-surface-candidate extraction unit 16g sets an auxiliary line 411 obtained by extending a bisector 250 of an interior angle starting from a vertex A to the outside of the region of the building H34. The installation-wall-surface-candidate extraction unit 16g sets auxiliary lines 412, 413, and 414 at the vertexes B, C, and D as well.

In the case of the building H30 shown in FIG. 39, the installation-wall-surface-candidate extraction unit 16g sets auxiliary lines 415 to 420 at vertexes A, B, C, D, E, and F.

The installation-wall-surface-candidate extraction unit 16g detects, based on the position indicated by the base station candidate position data, in which of a region divided by contour lines of the building or set auxiliary lines or a region surrounded by the contour lines of the building or the set auxiliary lines a utility pole is present (step Sg5).

The installation-wall-surface-candidate extraction unit 16g detects, based on the already detected unobstructed view ranges and the region where the utility pole is present, in the unobstructed view ranges, a candidate wall surface on which a terminal station is installed (step Sg6).

In the case of the building H34 shown in FIG. 38, the utility pole 46 is present in a region between the auxiliary line 411 of the bisector and the auxiliary line 361 in the region A. Accordingly, the installation-wall-surface-candidate extraction unit 16g prioritizes, among the unobstructed view ranges, the wall surface AB as the candidate wall surface on which the terminal station is installed and detects data indicating the wall surface AB.

In the case of the building H30 shown in FIG. 39, the unobstructed view ranges are a wall surface to the point indicated by the sign 501 and the vertex C, the wall surface CD, and the wall surface DE of the building H30. Concerning the vertex C, the utility pole 45 is located in a region divided by an auxiliary line 417 and an auxiliary line 307 obtained by extending a contour line. Concerning the vertex D, the utility pole 45 is located in a region divided by an auxiliary line 418 and an auxiliary line 305.

Accordingly, concerning the vertex C, the installation-wall-surface-candidate extraction unit 16g prioritizes, of the wall surface to the point indicated by the sign 501 and the vertex C and the wall surface CD, the wall surface CD as a candidate wall surface on which a terminal station is installed. Concerning the vertex D, the installation-wall-surface-candidate extraction unit 16g prioritizes, of the wall surface CD and the wall surface DE, the wall surface CD as a candidate wall surface on which a terminal station is installed. Therefore, the installation-wall-surface-candidate extraction unit 16g detects, with respect to the utility pole 45, among the unobstructed view ranges, data indicating the wall surface CD as the candidate wall surface on which the terminal station is installed.

The installation-wall-surface-candidate extraction unit 16g in the sixth embodiment explained above divides a region around a building with an auxiliary line obtained by extending a bisector of an interior angle of the building to the outside of a region of the building and an auxiliary line obtained by extending a contour line of the building and detects, based on in which of divided regions a position indicated by base station candidate position data is present, a wall surface of the building to be a candidate of an installation position of a terminal station device in an unobstructed view range. Consequently, it is possible to detect a wall surface in a direction further in the front in an unobstructed view from a utility pole among wall surfaces included in the unobstructed view range of the building. Accordingly, it is possible to set an antenna direction between a base station and a terminal station in a more satisfactory state.

### (About Comparison of the Embodiments)

FIG. 40 is a table in which overviews and characteristics of the embodiments are collected. As it is seen from the table, in configurations of 1 to 5) for performing “detection of an unobstructed view range of a building”, an effect of reducing a calculation amount is the highest in the fifth embodiment. By adopting a polar coordinate system, in the respective directions, simply by extracting a portion at the shortest distance from the position of a utility pole, it is possible to perform detection of an unobstructed view range. However, in the fifth embodiment, it is necessary to convert contour line data of a building into contour line data of the polar coordinate system beforehand.

The effect of reducing the calculation amount is the second highest in the third embodiment. In the third embodiment, since buildings are evaluated in order from the building at the shortest distance from a base station, it is possible to exclude a blocked building from targets without evaluating the building. Accordingly, the effect of reducing the calculation amount is large. However, in the third embodiment, it is necessary to number the buildings in order from the building closest from the position of a utility pole beforehand.

Compared with the fifth and third embodiments, in the first and second embodiments, although the effect of reducing the calculation amount changes depending on a disposition state of a plurality of buildings present in an evaluation target range, the effect of reducing the calculation amount can be expected. In the case of the second embodiment, by increasing a rotation angle when detection of an unobstructed view range is performed in a range in which the length of an unobstructed view detection line is short, that is, narrow and reducing the rotation angle when the detection of an unobstructed view range is performed in a wide range, it is possible to achieve a further reduction in the calculation amount.

Compared with the first, second, third, and fifth embodiments, in the fourth embodiment, although a higher reduction of the calculation amount cannot be expected, a reasonable effect can be expected. In the fourth embodiment, since directions in which unobstructed view ranges are detected are curtailed, although accuracy of the detection decreases, it is possible to achieve a reduction in the calculation amount. When the accuracy of the detection decreases, detection omission is likely to occur. However, since the detection of unobstructed view ranges is uniformly performed in the respective directions, it is possible to stably obtain information of a degree necessary for narrowing down point group data.

Comparison about effects of methods of “detection of an unobstructed view range performed when the shape of a building is complicated” in 6) and 7) applied to the first embodiment and the third embodiment is explained below. When the shape of a building is a rectangular shape, when the method described in Patent Literature 1 is applied, target wall surfaces can be narrowed down from four surfaces to one to two surfaces. Therefore, the target wall surfaces are reduced to a quarter to a half. In contrast, in the case of a building having a shape in which one auxiliary line can be set by vertexes of a projecting part, for example, the building H30 shown in FIG. 31, by applying the method of 6), target wall surfaces can be narrowed down from six surfaces to one to four surfaces. Therefore, the target wall surfaces can be reduced to one sixth to two third. In the case of a building having a shape in which two auxiliary lines can be set by vertexes of a projecting part, for example, the building H32 shown in FIG. 33, by applying the method of 7), target wall surfaces can be narrowed down from eight surfaces to one to five surfaces. Therefore, the target wall surfaces can be reduced to one eighths to five eighths. In the case of the building H33 shown in FIG. 34, by applying the method of 7), target wall surfaces can be narrowed down from eight surfaces to one to six surfaces. Therefore, the target wall surfaces can be reduced to one eighths to three fourths. Whereas only a rectangular shape can be treated in Patent Literature 1, there is an advantage that 6) and 7) can also be applied to a shape more complicated than the rectangular shape.

By applying a method of 8) for “detecting a wall surface having higher priority in an unobstructed view range”, for example, in the case of the building H34 having the rectangular shape shown in FIG. 38, among the wall surfaces included in the unobstructed view range detected in the configurations in the first to fifth embodiments, four surfaces can be narrowed down to one surface. Therefore, the wall surfaces can be reduced to a quarter. In the case of the building H30 having the rectangular shape shown in FIG. 39, among the wall surfaces included in the unobstructed view range detected in the configurations in the first to fifth embodiments, six surfaces can be narrowed down to one surface. Therefore, the wall surfaces can be reduced to one sixths.

Note that, in the configurations in the embodiments explained above, in the processing shown in FIG. 5, FIG. 11, FIG. 18, FIG. 21, and FIG. 25, the determination processing using the sign of inequality or the sign of inequality with the equality sign is performed. However, the present invention is not limited to the embodiments. The determination processing for determining “larger than”, “smaller than”, “equal to or larger than”, and “equal to or smaller than” is only an example. According to a method of deciding a threshold, the determination processing may be respectively replaced with determination processing for determining “equal to or larger than”, “equal to or smaller than”, “larger than”, and “smaller than”. The threshold used for the determination processing indicates only an example. Different thresholds may be applied in the respective kinds of the determination processing.

The configuration of the station installation support devices 1, 1a, 1b, 1c, 1d, and 1e, the configuration in which the configuration for detecting an unobstructed view range of the unobstructed-view-range detection units 144 and 144c is replaced with the unobstructed-view-range detection unit 144f in the station installation support devices 1a and 1c in the embodiments explained above, and a configuration in which the configuration in the sixth embodiment is applied to these configurations may be realized by a computer. In that case, the configurations may be realized by recording a program for realizing this function in a computer-readable recording medium, causing a computer system to read the program recorded in the recording medium, and executing the program. Note that the “computer system” includes an OS and hardware such as peripheral devices. The “computer-readable recording medium” means a portable medium such as a flexible disk, a magneto-optical disk, a ROM, or a CD-ROM or a storage device such as a hard disk incorporated in the computer system. Further, the “computer-readable recording medium” may include a recording medium that dynamically retains the program for a short time like a communication line in the case in which the program is transmitted via a network such as the Internet or a communication line such as a telephone line or a recording medium that retains the program for a fixed time like a volatile memory inside a computer system functioning as a server or a client in that case. The program may be a program for realizing a part of the functions explained above, may be a program that can realize the functions in combination with a program already recorded in the computer system, or may be a program realized using a programmable logic device such as an FPGA (Field Programmable Gate Array).

The embodiments of the present invention are explained in detail above with reference to the drawings. However, a specific configuration is not limited to the embodiments. Design and the like in a range not departing from the gist of the present invention are also included in the present invention.

### REFERENCE SIGNS LIST

1 Station installation support device
10 Map-data storage unit
11 Design-area designation unit
12 Equipment-data storage unit
13-1 Terminal-station-candidate-position extraction unit
13-2 Base-station-candidate-position extraction unit
14 Unobstructed-view-determination processing unit
15 Data storage unit
16 Installation-wall-surface-candidate extraction unit
17 Point-group-data storage unit
18 Point-group-data processing unit
19 Number-of-stations calculation unit

1. A station installation support method comprising:
an unobstructed-view-determination processing step for, in two-dimensional map data showing buildings to be candidates in which terminal station devices are to be installed, setting, as a base station candidate position, a position of a base station installation structure to be a candidate in which a base station device is to be installed, determining an unobstructed view for each of the buildings from the base station candidate position based on the map data while excluding a region blocked by the building having an unobstructed view from the base station candidate position, and detecting, as an unobstructed view range, a range of a contour line having an unobstructed view of the building determined as having the unobstructed view;
an installation-wall-surface-candidate extraction step for extracting a candidate of, among wall surfaces of the building corresponding to the detected unobstructed view range, the wall surface on which the terminal station device can be installed; and
a point-group-data processing step for narrowing down, using information concerning the extracted wall surface, three-dimensional point group data obtained by taking an image of a region including the base station installation structure and the building and determining, using the narrowed-down point group data, an unobstructed view for the building from the base station candidate position.

2. The station installation support method according to claim 1, wherein
the unobstructed-view-determination processing step includes:
an evaluation-range selection step for selecting, as an evaluation range of unobstructed view determination, a range that is centered on the base station candidate position and is to be expanded stepwise;
a building detection step for detecting, for each the evaluation range in respective stages, the building partially or entirely included in the evaluation range;
an unobstructed-view-range detection step for detecting, with respect to the detected building, a range of a contour line having an obstructed view of the building and detecting the detected range of the contour line as an unobstructed view range of the building; and
a blocking-direction detection step for detecting a range of a blocking direction blocked by the detected unobstructed view range, and
in the unobstructed-view-range detection step, when the entire building as an unobstructed view determination target is included in the range of the blocking direction, the building is excluded from detection targets of the contour line having the unobstructed view.

3. The station installation support method according to claim 1, wherein
the unobstructed-view-determination processing step includes:
an unobstructed-view-detection-line setting step for rotating, in one direction, an unobstructed view detection line starting from the base station candidate position, a line length of the unobstructed view detection line increasing stepwise;
an intersection detection step for detecting an intersection of the unobstructed view detection line and a contour line of the building, a distance of the intersection from the base station candidate position being smallest, and detecting intersection data indicating a coordinate of the detected intersection, building identification data indicating the building in which the intersection is present, line segment identification data indicating to which side of the building the intersection belongs, and direction data indicating a direction of the unobstructed view detection line;
an unobstructed-view-range detection step for extracting the intersection data in which the building identification data is same and the line segment identification data is same, generating a line segment connecting coordinates of the intersection data included in the extracted combination, and detecting the generated line segment as an unobstructed view range of the building corresponding to the building identification data; and
a blocking-direction detection step for detecting a range of a blocking direction blocked by the detected unobstructed view range, and
in the intersection detection step, when the intersection corresponding to the direction of the unobstructed view detection line is already detected or when the direction of the unobstructed view detection line is included in the blocking direction, the detection of the intersection is not performed.

4. The station installation support method according to claim 3, in the unobstructed-view-range detection step, when a coordinate of a vertex of the building is included in an inside of a circle forming a track of an end point at a time when the unobstructed view detection line is rotated once, the detection of the unobstructed view range is performed and, when the coordinate of the vertex of the building is not included in the inside of the circle, the detection of the unobstructed view range is not performed.

5. The station installation support method according to claim 1, wherein
the unobstructed-view-determination processing step includes:
a distance detection step for detecting, for each the building, a distance from the base station candidate position;
an unobstructed-view-range detection step for detecting buildings having unobstructed views in order from the building, the distance of which from the base station candidate position is shortest, detecting a range of a contour line having an unobstructed view of the building having the unobstructed view, and detecting the detected contour line as an unobstructed view range of the building; and
a blocking-direction detection step for detecting a range of a blocking direction blocked by the detected unobstructed view range, and
in the unobstructed-view-range detection step, when the entire building as an unobstructed view determination target is included in the range of the blocking direction, the building is excluded from detection targets of the contour line having the unobstructed view.

6. The station installation support method according to claim 1, wherein
the unobstructed-view-determination processing step includes:
a detection-direction setting step for setting one direction determined in advance around the base station candidate position as a designated detection direction and setting, as an auxiliary detection direction, an angle rotated at a predetermine rotation angle interval with respect to the designated detection direction;
an intersection detection step for detecting an intersection with a contour line of the building that a straight line extended in the designated detection direction or the auxiliary detection direction starting from the base station candidate position crosses first and detecting intersection data indicating a coordinate of the detected intersection, building identification data indicating the building in which the intersection is present, and line segment identification data indicating to which side of the building the intersection belongs;
a blocking-direction detection step for, when a pair or more of the intersections detected by the intersection detection step are present in the same building, detecting a range of a blocking direction based on the designated detection direction or the auxiliary detection direction at a time when each of the intersections is detected; and
an unobstructed-view-range detection step for extracting the intersection data in which the building identification data is same and the line segment identification data is same, generating a line segment connecting coordinates of the intersection data included in the extracted combination, and detecting the generated line segment as an unobstructed view range of the building corresponding to the building identification data,
in the detection-direction setting step, when the angle in the auxiliary detection direction is 360° or more, a half angle of the predetermined rotation angle interval is set as a new predetermined rotation angle interval, an angle rotated at the new predetermined rotation angle interval in the designated detection direction is set as the auxiliary detection direction, and
in the intersection detection step, when a direction of the designated detection direction or the auxiliary detection direction is included in the range of the blocking direction, the detection of the intersection is not performed.

7. The station installation support method according to claim 1, wherein the unobstructed-view-determination processing step includes:
a polar-coordinate-data generation step for generating, for each the building, contour line data of an orthogonal coordinate system indicating a contour line of the building included in the map data and converting the generated contour line data of the orthogonal coordinate system for each the building into contour line data of a polar coordinate system indicated by a distance and a direction based on the base station candidate position; and
an unobstructed-view-range detection step for extracting the contour line data of the polar coordinate system in a portion at a shortest distance from the base station candidate position in respective directions and dividing the detected contour line data of the polar coordinate system for each the building and detecting, as an unobstructed view range for each the building, the contour line data of the polar coordinate system divided for each the building.

8. The station installation support method according to claim 2, wherein, in the unobstructed-view-range detection step, when a shape of the building is a shape having a projecting part obtained by combining a rectangular shape with a rectangular shape, the unobstructed view range of the building is detected based on a plurality of regions obtained by dividing a region other than the region of the building with an auxiliary line obtained by extending the contour line of the building and an auxiliary line obtained by extending a line connecting a vertex of the projecting part and another vertex of the building viewed without obstruction from the vertex of the projecting part through an outside of the region of the building and based on the base station candidate position.

9. The station installation support method according to claim 1, wherein, in the installation-wall-surface-candidate extraction step, a region around the building is divided by an auxiliary line obtained by extending a bisector of an interior angle of the building to an outside of the region of the building and an auxiliary line obtained by extending the contour line of the building and detecting, based on in which of divided regions the base station candidate position is present, a wall surface of the building to be a candidate of an installation position of the terminal station device in the unobstructed view range detected by the unobstructed-view-range detection step.
